(19) United States
(12) Patent Application Publication
(10) Pub. No.: US 2024/0256193 A1
(43) Pub. Date: Aug. 1, 2024

(54) PRINTING APPARATUS, DATA TRANSFERRING METHOD AND MEDIUM

(71) Applicant: BROTHER KOGYO KABUSHIKI KAISHA, Nagoya (JP)

(72) Inventor: Takuya KOJIMA, Nagoya (JP)

(21) Appl. No.: 18/427,234

(22) Filed: Jan. 30, 2024

(30) Foreign Application Priority Data
Jan. 31, 2023 (JP) 2023-013562

(51) Int. Cl. G06F 3/12

(52) U.S. Cl. CPC G06F 3/122; G06F 3/1236

(57) ABSTRACT

There is provided a printing apparatus including: a main control circuit; a sub-control circuit group; and a head group. The sub-control circuit group includes a first sub-control circuit and a second sub-control circuit. The main control circuit is configured to reserve a main communication address space. The first sub-control circuit is configured to reserve a first sub-communication address space, and includes a first sub-memory. The first sub-control circuit is configured to: in a case that the data is written into a first main communication address space reserved in the main communication address space, write the data written into the first main communication address space into the first sub-memory; and in a case that the data is written into a second main communication address space reserved in the main communication address space, write the data written into the second main communication address space into the first sub-communication address space.

### REFERENCE TO RELATED APPLICATIONS

This application claims priority from Japanese Patent Application No. 2023-013562 filed on Jan. 31, 2023. The entire content of the priority application is incorporated herein by reference.

### BACKGROUND ART

A printing apparatus including a controller and a plurality of liquid jetting heads connected to the controller via daisy chain connection is proposed. Each of the heads includes a control circuit. Printing data for all heads is transmitted from the controller to the most upstream control circuit and then transferred down to the most downstream control circuit.

### SUMMARY

Each of the control circuits reads the print data for all of the liquid jetting heads one by one, and then extracts and stores printing data for itself.

The present disclosure has been made in view of the above situation. The purpose of the present disclosure is to provide a printing apparatus, a data transferring method, and a medium that can store printing data for itself without causing the control circuit of each of the heads to read the printing data.

A printing apparatus according to a first aspect of the present disclosure is a printing apparatus including: a main control circuit; a sub-control circuit group connected to the main control circuit in series, the sub-control circuit group being configured to transfer data from the main control circuit downstream; and a head group configured to be driven by the sub-control circuit group based on the data. The sub-control circuit group includes a first sub-control circuit connected to the main control circuit, and a second sub-control circuit positioned downstream of the first sub-control circuit. The main control circuit is configured to reserve a main communication address space in the main control circuit. The first sub-control circuit is configured to reserve a first sub-communication address space in the sub-control circuit. The first sub-control circuit includes a first sub-memory. The first sub-control circuit is configured to: in a case that the data is written into a first main communication address space, write the data written into the first main communication address space into the first sub-memory, the first main communication address space being reserved in the main communication address space and being correlated with the first sub-memory; and in a case that the data is written into a second main communication address space reserved in the main communication address space, write the data written into the second main communication address space into the first sub-communication address space.

A data transferring method according to a second aspect of the present disclosure is a data transferring method executed in a printing apparatus, the printing apparatus including: a main control circuit; a sub-control circuit group connected to the main control circuit in series, the sub-control circuit group being configured to transfer data from the main control circuit downstream; and a head group configured to be driven by the sub-control circuit group based on the data, wherein: the sub-control circuit group includes a first sub-control circuit connected to the main control circuit, and a second sub-control circuit positioned downstream of the first sub-control circuit; the main control circuit is configured to reserve a main communication address space in the main control circuit; the first sub-control circuit is configured to reserve a first sub-communication address space in the first sub-control circuit, and the first sub-control circuit includes a first sub-memory. The method includes: in a case that the data is written into a first main communication address space, write the data written into the first main communication address space into the first sub-memory by the first-sub control circuit, the first main communication address space being reserved in the main communication address space and being correlated with the first sub-memory; and in a case that the data is written into a second main communication address space reserved in the main communication address space, write the data written into the second main communication address space into the first sub-communication address space by the first-sub control circuit.

A medium according to a third aspect of the present disclosure is a non-transitory computer-readable medium storing a program that is executable by a printing apparatus, the printing apparatus including: a main control circuit; a sub-control circuit group connected to the main control circuit in series, the sub-control circuit group being configured to transfer data from the main control circuit downstream; and a head group configured to be driven by the sub-control circuit group based on the data, wherein: the sub-control circuit group includes a first sub-control circuit connected to the main control circuit, and a second sub-control circuit positioned downstream of the first sub-control circuit; the main control circuit is configured to reserve a main communication address space in the main control circuit; and the first sub-control circuit is configured to reserve a first sub-communication address space in the first sub-control circuit; and the first sub control circuit includes a first sub-memory. The program is configured to cause the first sub-control circuit to execute a process of: in a case that the data is written into a first main communication address space, writing the data written into the first main communication address space into the first sub-memory, the first main communication address space being reserved in the main communication address space and being correlated with the first sub-memory; and in a case that the data is written into a second main communication address space reserved in the main communication address space, writing the data written into the second main communication address space into the first sub-communication address space.

In the printing apparatus, the data transferring method and the medium according to an aspect of the present disclosure, the first main communication address space of the main control circuit and the first sub-memory area of the first sub-control circuit are correlated with each other. The first sub-control circuit is configured to write data written into the first main communication address space into the first sub-memory area. The first sub-control circuit can store the data in the first sub-memory area without reading the data. The data written into the second main communication address space is written into the first sub-communication address space. The data written into the first sub-communication address space is transferred downstream.

### BRIEF DESCRIPTION OF DRAWINGS

FIG. 1 is schematic plan view of a printing apparatus.

FIG. 2 is a planar perspective view of an inkjet head.

FIG. 3 is a block diagram of a controller and the inkjet head.

FIG. 4 is an explanatory diagram illustrating a relationship among a communication address space, sub-receiving address spaces, sub-transmitting address spaces, and memories of sub-control circuits.

FIG. 5 is an explanatory diagram illustrating a relationship among a memory of a main control circuit, the sub-receiving address spaces and the sub-transmitting address spaces.

FIG. 6 is an explanatory diagram illustrating a relationship among the memory of the main control circuit, the sub-receiving address spaces and the sub-transmitting address spaces.

FIG. 7 is an explanatory diagram illustrating a relationship among the communication address space, the sub-receiving address spaces, the sub-transmitting address spaces, and resisters of the sub-control circuits.

FIG. 8 is an explanatory diagram illustrating a relationship among the memory of the main control circuit, the sub-receiving address spaces and the sub-transmitting address spaces.

FIG. 9 is a flowchart illustrating a printing process by the main control circuit.

FIG. 10 is a flowchart illustrating a printing process by the sub-control circuit.

FIG. 11 is a flowchart illustrating a printing process by the main control circuit.

FIG. 12 is a flowchart illustrating a printing process by the sub-control circuit.

FIG. 13 is a flowchart illustrating a printing process by the main control circuit.

FIG. 14 is a flowchart illustrating a printing process by the sub-control circuit.

### DESCRIPTION

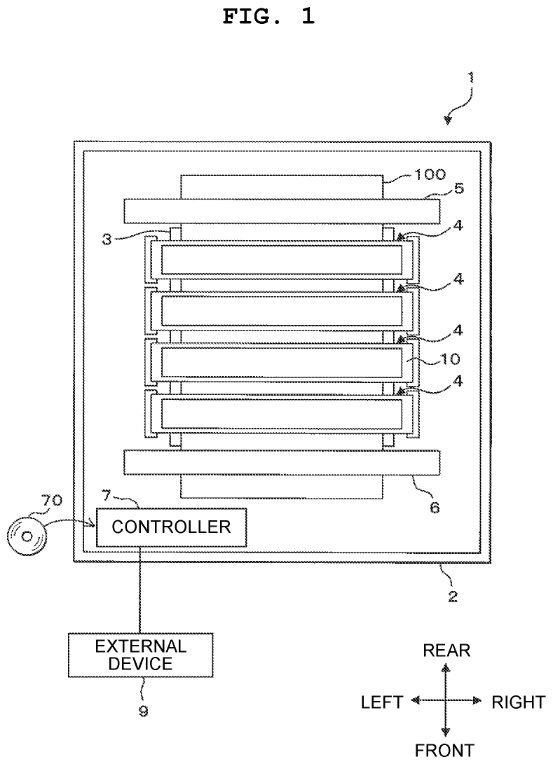

The present disclosure will be explained below based on the drawings depicting the printing apparatus according to the embodiment. FIG. 1 is a schematic plan view of the printing apparatus 1. In FIG. 1, a conveying direction of a recording paper 100 corresponds to a front-rear direction of the printing apparatus 1. A width direction of the recording paper 100 corresponds to a left-right direction of the printing apparatus 1. The direction orthogonal to the front-rear direction and the left-right direction, that is the direction vertical to the paper surface of FIG. 1, corresponds to an up-down direction of the printing apparatus 1.

As depicted in FIG. 1, the printing apparatus 1 includes a platen 3 housed in a case 2, four inkjet heads 4, two transporting rollers 5 and 6, and a controller 7, etc. A recording paper 100 passes over the top surface of the platen 3. The four inkjet heads 4 are arranged in the conveying direction at a position above the platen 3. Each of the four inkjet heads 4 is a so-called line-type head. Ink is supplied to the inkjet heads 4 from an ink tank (not depicted). Inks having different colors from each other are supplied to the four inkjet heads 4.

As depicted in FIG. 1, the two conveying rollers 5 and 6 are arranged at the rear and front of the platen 3, respectively. Each of the two conveying rollers 5 and 6 is driven by undepicted motor, and conveys the recording paper 100 on the platen 3 forward. The two conveying rollers 5 and 6 correspond to the conveyor. The controller 7 controls the printing apparatus 1 based on a control program. The controller 7 is connected to an external device 9, such as a PC, in a manner that data communication therebetween is possible. The controller 7 executes printing by driving each part of the printing apparatus 1 based on printing data transmitted from the external device 9.

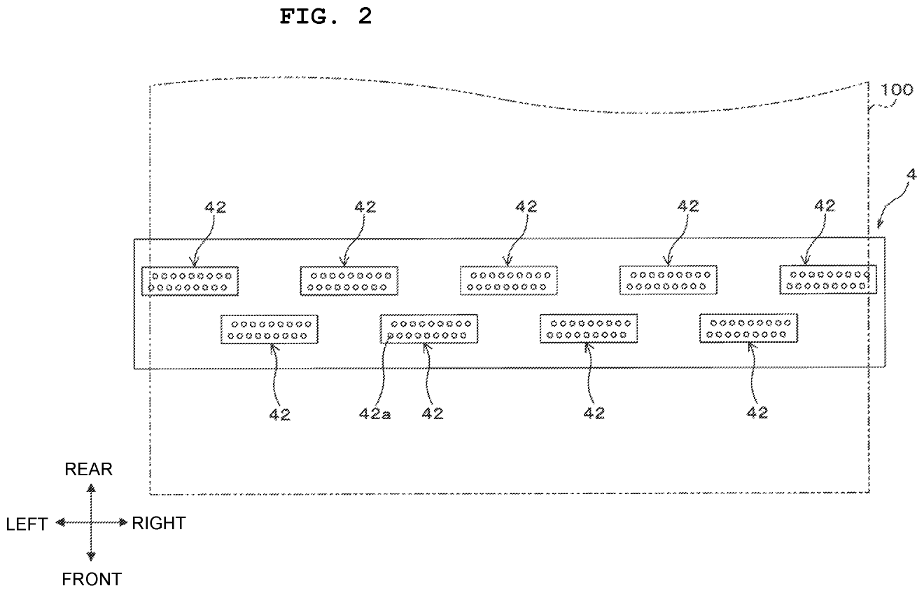

FIG. 2 is a planar perspective view of the inkjet head 4. The inkjet head 4 includes a plurality of heads 42 (a first head to a third head). The head 42 corresponds to a head unit. The plurality of heads 42 is arranged in two rows in the front-rear direction. In the front row, four heads 42 are arranged along the left-right direction, and in the rear row, five heads 42 are arranged along the left-right direction. A plurality of nozzles 42a is provided on the under surface of the head 42. Note that the number of the heads 42 and the number of the rows of the heads 42 are not limited and can be changed.

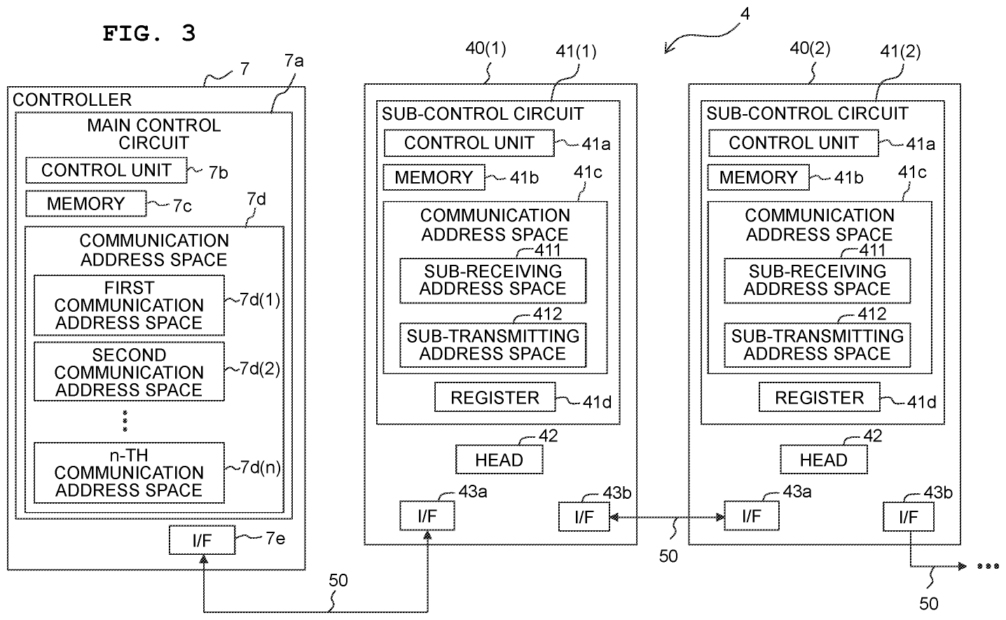

FIG. 3 is a block diagram of the controller 7 and an inkjet head 4. The controller 7 includes a main control circuit 7a. The main control circuit 7a includes a control unit 7b, a memory 7c (a main memory area), a communication address space 7d (main communication address space), and a communication interface (I/F) 7e. The control unit 7b includes a logic circuit, for example, FPGA. Note that the control unit 7b may include a processor, for example, a CPU or an ASIC, etc. The memory 7c is, for example, a main storage device. The communication address space 7d includes, for example, a storage area of the main storage device or an auxiliary storage device. The communication address space 7d is reserved (secured) in the main storage device or the auxiliary storage device for performing communication with sub-control circuits 41 described below. The communication address space 7d may be a virtual address space or a physical address space. The communication address space 7d includes at least one address and a storage area corresponding to each address. The communication address space 7d corresponds to the main communication address space.

An example of the main storage device may be, for example, RAM. Examples of the auxiliary storage device may be, for example, ROM and rewritable storage media, such as EEPROM, EPROM, hard disk, etc. The control program is stored in the auxiliary storage device. The control unit 7b reads the control program from the auxiliary storage device to the main storage device, for example, and executes the control program. The control program may be installed in the auxiliary storage device from a recording medium 70 (see FIG. 1) which is, for example, an optical disk or a portable flash memory. Note that the control program may also be downloaded to the auxiliary storage device from a server connected to the printing apparatus 1 via a communication network. The communication I/F 7e is connected to the data communication channel (communication cable) 50. The controller 7 controls the printing apparatus 1 based on the control program.

The inkjet head 4 includes a plurality of head modules 40. The plurality of head modules 40 is arranged on a single line in the left-right direction, for example. The plurality of head modules 40 includes, for example, a first head module 40(1), a second head module 40(2), . . . , and an n-th head module 40(n) (n is a natural number. In the embodiment, n may be nine). The first head module 40(1) is the leftmost, and the n-th head module 40(n) is the rightmost. The first head module 40(1) is positioned closest to the controller 7 among all of the head modules 40, and the n-th head module 40(n) is positioned farthest from the controller 7 among all of the head modules 40.

Each of the first head module 40(1) to the n-th head module 40(n) includes a sub-control circuit 41 (a first sub-control circuit to a third sub-control circuit), the head 42, an upstream I/F 43a, and a downstream I/F 43b. The plurality of heads constitutes a head group. The sub-control circuit 41 includes a control unit 41a, a memory 41b, a communication address space 41c (a first sub-communication address space to a third sub-communication address space), and a register 41d. The sub-control circuit 41 includes, for example, an ASIC or SoC. The sub-control circuit 41 drives the head 42 based on an image data. The plurality of sub-control circuits 41 corresponds to a sub-control circuit group. The communication address spaces 41c of the sub-control circuits 41 correspond to the first to third sub-communication address spaces, respectively. The memories 41b of the sub-control circuits 41 correspond to the first to third sub-memory areas, respectively.

The control unit 41a controls the operation of the sub-control circuit 41. The control unit 41a may include a CPU, for example, or a logic circuit such as an FPGA. The memory 41b is a rewritable nonvolatile memory, such as EPROM or EEPROM, for example.

The communication address space 41c includes a sub-receiving address space 411 (first or second sub-receiving address space) and a sub-transmitting address space 412 (first or second sub-transmitting address space). The sub-receiving address space 411 and the sub-transmitting address space 412 may be virtual address spaces or physical address spaces. The sub-control circuit 41 includes one or more storage device(s). The sub-receiving address space 411 and the sub-transmitting address space 412 may be provided in a storage device same as a storage device in which the memory 41b is provided or in a storage device different from the storage device in which the memory 41b is provided. The sub-receiving address space 411 and the sub-transmitting address space 412 are reserved in the storage device for performing communication with the main control circuit 7a or with the upstream and downstream sub-control circuits 41. The sub-receiving address space 411 has at least one address and storage area(s) corresponding to the address(es), respectively. The sub-transmitting address space 412 has at least one address and storage area(s) corresponding to the address(es), respectively.

Hereafter, the sub-control circuits 41 of the first head module 40(1) to the n-th head module 40 (n) are also referred to as the sub-control circuit 41(1) to the sub-control circuit 41(n), respectively. The sub control circuit 41(1) to the sub-control circuit 41(n) correspond to the first sub-control circuit to the third sub-control circuit, respectively.

Each of the I/Fs 7e, 43a, 43b is an interface capable of preforming bidirectional communication and is connected in series by connectors and the data communication channel 50. Each of the I/Fs 7e, 43a, 43b is a device based on a high-speed serial interface standard, for example, PCIe. The I/F 7e transmits the image data contained in the printing data to the I/F 43a of the sub-control circuit 41(1). The I/F 43b of the sub-control circuit 41(1) transfers the image data to the I/F 43a of the sub-control circuit 41(2), and the I/F 43b of the sub-control circuit 41(2) transmits the image data to the I/F 43a of the sub-control circuit 41(3). In this way, the image data is transferred serially down to the I/F 43a of the sub-control circuit 41(n).

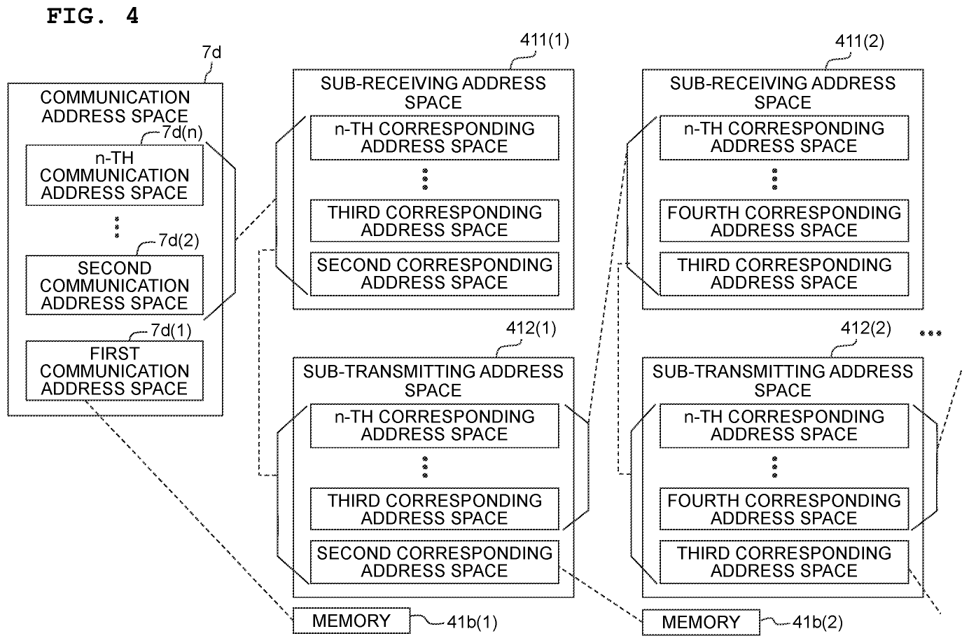

In the following, “writing of data into memories of sub-control circuits” will be described. FIG. 4 is an explanatory diagram illustrating a relationship among the communication address space 7d, and the sub-receiving address spaces 411, the sub-transmitting address spaces 412, and the memories 41b of the sub-control circuits 41, related to the writing of the data into the memories of the sub-control circuits. In FIG. 4, the sub-receiving address spaces of the sub-control circuit 41(1) to the sub-control circuit 41(n) are denoted as the sub-receiving address spaces 411(1) to the sub-receiving address space 411(n), respectively; and the sub-transmitting address spaces of the sub-control circuits 41(1) to the sub-control circuit 41(n) are denoted as the sub-transmitting address space 412(1) to the sub-transmitting address space 412(n), respectively. The memories of the sub-control circuit 41(1) to the sub-control circuit 41(n) are denoted as the memory 41b(1) to the memory 41b(n), respectively. The memory 41b(1) to the memory 41b(n) correspond to the first sub-memory area to the third sub-memory area.

Before performing printing, for example, when the printing apparatus 1 is started up, the main control circuit 7a communicates with each of the sub-control circuit 41(1) to the sub-control circuit 41(n) to reserve a communication address spaces corresponding to the number of the heads 42 (the number of the head modules 40 or the number of the sub-control circuits 41). In this example, the number of the heads 42 is n pieces, and thus n pieces of address spaces, that is, the first communication address space 7d(1) to the n-th communication address space 7d(n), are reserved in the communication address space 7d. The first communication address space 7d(1) to the n-th communication address space 7d(n) correspond to the first main communication address space to the third main communication address space.

The sub-control circuit 41(1) reserves, in the sub-receiving address space 411(1), a second corresponding address space to a n-th corresponding address space corresponding to the second communication address space 7d(2) to the n-th communication address space 7d(n). The sub-control circuit 41(1) reserves, in a the sub-transmitting address space 412(1), the second corresponding address space to the n-th corresponding address space corresponding to the second communication address space 7d(2) to the n-th communication address space 7d(n).

The sub-control circuit 41(2) reserves, in the sub-receiving address space 411(2), the third corresponding address space to the n-th corresponding address space corresponding to the third communication address space 7d(3) to the n-th communication address space 7d(n). The sub-control circuit 41(2) reserves, in a the sub-transmitting address space 412(2), the third corresponding address space to the n-th corresponding address space corresponding to the third communication address space 7d(3) to the n-th communication address space 7d(n). The address spaces are similarly reserved in each of the sub-control circuit 41(3) to the sub-control circuit 41(n).

That is, the sub-control circuit 41(k) (k is 1 to n−1) reserves, in the sub-receiving address space 411(k), the (k+1)-th corresponding address space to the n-th corresponding address space corresponding to the (k+1)-th communication address space 7d(k+1) to the n-th communication address space 7d(n). The sub-control circuit 41(k) reserves, in the sub-transmitting address space 412(k), the (k+1)-th corresponding address space to the n-th corresponding address space corresponding to the (k+1)-th communication address space 7d (k+1) to the n-th communication address space 7d(n).

The main control circuit 7a and the sub-control circuit 41(1) correlate (link) the first communication address space 7d(1) with the memory 41b(1). That is, the main control circuit 7a and the sub-control circuit 41(1) assign the address of the first communication address space 7d(1) to the memory 41b(1). The main control circuit 7a and the sub-control circuit 41(1) correlate the second communication address space 7d(2) to the n-th communication address space 7d(n) with the second corresponding address space to the n-the corresponding address space of the sub-receiving address space 411(1), respectively. That is, the main control circuit 7a and the sub-control circuit 41(1) assign the addresses of the second communication address space 7d(2) to the n-th communication address space 7d(n) to the second corresponding address space to the n-the corresponding address space of the sub-receiving address space 411(1), respectively. The sub-control circuit 41(1) correlate the second corresponding address space to the n-th corresponding address space of the sub-receiving address space 411(1) with the second corresponding address apace to the n-th corresponding address space of the sub-transmitting address space 412(1). That is the sub-control circuit 41(1) assigns addresses of the second corresponding address space to the n-th corresponding address space of the sub-receiving address space 411(1) to the second corresponding address space to the n-th corresponding address space of the sub-transmitting address space 412(1), respectively.

The sub-control circuit 41(1) and the sub-control circuit 41(2) correlate the second corresponding address space of the sub-transmitting address space 412(1) with the memory 41b(2). That is, the sub-control circuit 41(1) and the sub-control circuit 41(2) assign the address of the second corresponding address space of the sub-transmitting address space 412(1) to the memory 41b(2). The sub-control circuit 41(1) and the sub-control circuit 41(2) correlate the third corresponding address space to the n-th corresponding address space of the sub-transmitting address space 412(1) to the third corresponding address space to the n-th corresponding address space of the sub-receiving address space 411(2), respectively. That is, the sub-control circuit 41(1) and the sub-control circuit 41(2) assign the addresses of the third corresponding address space to the n-th corresponding address space of the sub-transmitting address space 412(1) to the third corresponding address space to the n-th corresponding address space of the sub-receiving address space 411(2), respectively.

That is, the sub-control circuit 41(k) and the sub-control circuit 41(k+1) (k is 1 to n−2) correlate the (k+1)-th corresponding address space of the sub-transmitting address space 412(k) with the memory 41b(k+1). That is, the sub-control circuit 41(k) and the sub-control circuit 41(k+1) assign the address of the (k+1)-th corresponding address space of the sub-transmitting address space 412(k) to the memory 41b(k+1). The sub-control circuit 41(k) and the sub-control circuit 41(k+1) correlate the (k+2)-th corresponding address space to the n-th corresponding address space of the sub-transmitting address space 412(k) with the (k+2)-th corresponding address space to the n-th corresponding address space of the sub-receiving address space 411(k+1), respectively. That is, the sub-control circuit 41(k) and the sub-control circuit 41(k+1) assign the addresses of the (k+2)-th corresponding address space to the n-th corresponding address space of the sub-transmitting address space 412(k) to the (k+2)-th corresponding address space to the n-th corresponding address space of the sub-receiving address space 411(k+1).

The sub-control circuit 41(n−1) and the sub-control circuit 41(n) correlate the n-th corresponding address space of the sub-transmitting address space 412(n−1) with the memory 41b(n). That is, the sub-control circuit 41(n−1) and the sub-control circuit 41(n) assign the address of the n-th corresponding address space of the sub-transmitting address space 412(n−1) to the memory 41b(n). In other words, the first communication address space 7d(1) to the n-th communication address space 7d(n) of the main control circuit 7a are correlated respectively with the memory 41b(1) to the memory 41b(n) of the sub-control circuit 41(1) to the sub-control circuit 41(n).

After the completion of the assignment of the addresses, the control unit 7b sends an image data to each of the memories 41b(1) to 41b(n) of the sub-control circuits 41(1) to 41(n) for performing printing. Specifically, the control unit 7b obtains an image data from the external device 70. The image data includes a first data to an n-th data corresponding to the head modules 40(1) to 40(n). In a case that the control unit 7b writes the first data to the n-th data into the first communication address space 7d(1) to the n-th communication address space 7d(n), respectively, the first data to the n-th data are written into the memories 41b(1) to 41b(n), respectively. Specifically, since the first communication address space 7d(1) is correlated with the memory 41b(1), in a case that the control unit 7b writes the first data into the first communication address space 7d(1), the sub-control circuit 41(1) writes the first data into the memory 41b(1).

Since the k-th communication address space 7d(k) and the memory 41b(k) are correlated with each other, the sub-control circuit 41(k) writes the data written into the k-th communication address space 7d(k) into the memory 41b(k), without adding a header to the data to describe the destination of the data and without checking the destination described in the header. That is, in a case that the control unit 7b writes the k-th data into the k-th communication address space 7d (k) (k is a natural number), the sub-control circuit 41(k) writes the k-th data into the memory 41b(k). The sub-control circuit 41(k) can store the k-th data in the memory 41b(k) without reading the data. The writing of data into the k-th communication address space 7d(k) by the control circuit 7b achieves the effect as if the data were directly written into the memory 41b(k).

The sub-control circuit 41(k) writes the (k+1)-th data to the n-th data into the sub-receiving address space 411(k) and also into the sub transmitting address space 412(k). The (k+1)-th data to the n-th data, that is, the data written into the sub-transmitting address space 412(k), are transferred downstream. The sub-control circuit 41(k) transfers the (k+1)-th data to the n-th data to the downstream side without attaching a header to the data to describe the destination of the data and without checking the destination described in the header. That is, the sub-control circuit 41(k) can transfer the (k+1)-th data to the n-th data to the downstream side without reading the data. Specifically, the second communication address space 7d(2) is correlated with the second corresponding address space of the sub-receiving address space 411(1), the second corresponding address space of the sub-receiving address space 411(1) is correlated with the second corresponding address space of the sub-transmitting address space 412(1), and the second corresponding address space of the sub-transmitting address space 412(1) is correlated with the memory 41b(2), and thus, the second communication address space 7d(2) is correlated with the memory 41b(2). Since the second communication address space 7d(2) and the memory 41b(2) are correlated with each other, in a case that the control unit 7b writes the second data into the second communication address space 7d(2), the sub-control circuit 41(1) writes the second data into the sub-receiving address space 411(1) and also into the sub-transmitting address space 412(1), and further into the memory 41b(2). That is, the second data written into the second communication address space 7d(2) is written into the memory 41b(2).

Specifically, the third communication address space 7d(3) is correlated with the third corresponding address space of the sub-receiving address space 411(1), the third corresponding address space of the sub-receiving address space 411(1) is correlated with the third corresponding address space of the sub-transmitting address space 412(1), the third corresponding address space of the sub-transmitting address space 412(1) is correlated with the third corresponding address space of the sub-receiving address space 411(2), the third corresponding address space of the sub-receiving address space 411(2) is correlated with the third corresponding address space of the sub-transmitting address space 412(2), and the third corresponding address space of the sub-transmitting address space 412(2) is correlated with the memory 41b(3), and thus, the third communication address space 7d(3) is correlated with the memory 41b(3). Since the third communication address space 7d(3) and the memory 41b(3) are correlated with each other, in a case that the control unit 7b writes the third data into the third communication address space 7d(3), the sub-control circuit 41(1) writes the third data into the sub-receiving address space 411(1) and also into the sub-transmitting address space 412(1); and the sub-control circuit 41(2) writes the third data into sub-receiving address space 411(2) and also into the sub-transmitting address space 412(2); and the sub-control circuit 41(3) writes the third data into the memory 41b(3). That is, the third data written into the third communication address space 7d(3) is written into the memory 41b(3).

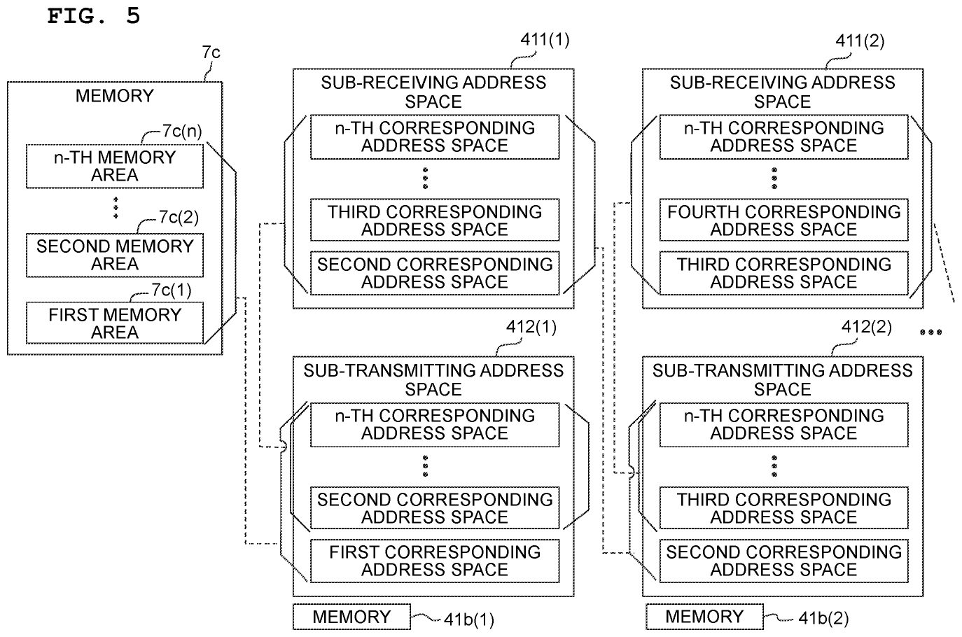

In the following, “writing of data into a memory area of a controller and reading of data out from the memory area of the controller, via a communication address space of a sub-control circuit” will be described. FIG. 5 is an explanatory diagram illustrating the relationship among the memory 7c of the main control circuit 7a, the sub-receiving address spaces 411 and the sub-transmitting address spaces 412, related to the writing of the data into the memory area of the controller and the reading of the data out from the memory area of the controller, via the communication address space of the sub-control circuit. Before performing the printing, for example when the printing apparatus 1 is started up, the main control circuit 7a communicates with each of the sub-control circuits 41(1) to 41(n) to reserve memory areas as many as the number of the heads 42 in the memory 7c.

The sub-control circuit 41(1) reserves, in the sub-receiving address space 411(1), the second corresponding address space to the n-th corresponding address space corresponding to the second memory are 7c(2) to the n-th memory area 7c(n). The sub-control circuit 41(1) reserves, in the sub-transmitting address space 412(1), the first corresponding address space to the n-th corresponding address space corresponding to the first memory area 7c(1) to the n-th memory area 7c(n) (first to third main memory areas).

Sub-control circuit 41(2) reserves, in the sub-receiving address space 411(2), the third corresponding address space to the n-th corresponding address space corresponding to the third memory area 7c(3) to the n-th memory area 7c(n). The sub-control circuit 41(2) reserves, in the sub-transmitting address space 412(2), the second corresponding address space to the n-th corresponding address space corresponding to the second memory area 7c(2) to the n-th memory area 7c(n).

That is, the sub-control circuit 41(k) (k is 1 to n−1) reserves, in the sub-receiving address space 411(k), the (k+1)-th corresponding address space to the n-th corresponding address space corresponding to the (k+1)-th memory area 7c(k+1) to the n-th memory area 7c(n). The sub-control circuit 41(k) reserves, in the sub-transmitting address space 412(k), the k-th corresponding address space to the n-th corresponding address space corresponding to the k-th memory area 7c(k) to the n-th memory area 7c(n). The sub-control circuit 41(n) reserves the n-th corresponding address space corresponding to the n-th memory area 7c(n) in the sub transmitting address space 412(n).

The main control circuit 7a and the sub-control circuit 41(1) correlate the first memory area 7c(1) to the n-th memory area 7c(n) with the first corresponding address space to the n-th corresponding address space of the sub-transmitting address space 412(1). That is, the main control circuit 7a and the sub-control circuit 41(1) assign the addresses of the first memory area 7c(1) to the n-th memory area 7c(n) to the first corresponding address space to the n-th corresponding address space of the sub-transmitting address space 412(1), respectively. The sub-control circuit 41(1) correlates the second corresponding address space to the n-th corresponding address space of the sub-receiving address space 411(1) with the second corresponding address space to the n-th corresponding address space of the sub-transmitting address space 412(1), respectively. That is, the sub-control circuit 41(1) assigns the addresses of the second corresponding address space to the n-th corresponding address space of the sub-transmitting address space 412(1) to the second corresponding address space to the n-th corresponding address space of the sub-receiving address space 411(1), respectively.

The sub-control circuit 41(1) and the sub-control circuit 41(2) correlate the second corresponding address space to the n-th corresponding address space of the sub-receiving address space 411(1) with the second corresponding address space to the n-th corresponding address space of the sub-transmitting address space 412(2). That is, the sub-control circuit 41(1) and the sub-control circuit 41(2) assign the addresses of the second corresponding address space to the n-th corresponding address space of the sub-receiving address space 411(1) to the second corresponding address space to the n-th corresponding address space of the sub-transmitting address space 412(2), respectively. The sub-control circuit 41(2) correlates the third corresponding address space to the n-th corresponding address space of the sub-receiving address space 411(2) with the third corresponding address space to the n-th corresponding address space of the sub-transmitting address space 412(2). That is, the sub-control circuit 41(2) assigns the address of the third corresponding address space to the n-th corresponding address space of the sub-transmitting address space 412(2) to the third corresponding address space to the n-th corresponding address space of the sub-receiving address space 411(2), respectively.

That is, the sub-control circuit 41(k) and the sub-control circuit 41(k+1) (k is 1 to n−2) correlate the (k+1)-th corresponding address space to the n-th corresponding address space in the sub-receiving address space 411(k) with the (k+1)-th corresponding address space to the n-th corresponding address space of the sub-transmitting address space 412(k+1). That is, the sub-control circuit 41(k) and the sub-control circuit 41(k+1) assign the addresses of the (k+1)-th corresponding address space to the n-th corresponding address space of the sub-receiving address space 411(k) to the (k+1)-th corresponding address space to the n-th corresponding address space of the sub-transmitting address space 412(k+1), respectively. The sub-control circuit 41(k+1) correlates the (k+2)-th corresponding address space to the n-th corresponding address space of the sub-receiving address space 411(k+1) with the (k+2)-th corresponding address space to the n-th corresponding address space of the sub-transmitting address space 412 (k+1). That is, the sub-control circuit 41(k+1) assigns the addresses of the (k+2)-th corresponding address space to the n-th corresponding address space of the sub-transmitting address space 412 (k+1) to the (k+2)-th corresponding address space to the n-th corresponding address space of the sub-receiving address space 411(2), respectively.

The sub-control circuit 41(n−1) and the sub-control circuit 41(n) correlates the n-th corresponding address space of the sub-receiving address space 411(n−1) with the n-th corresponding address space of the sub-transmitting address space 412(n). That is, the sub-control circuit 41(n−1) and the sub-control circuit 41(n) assign the address of the n-th corresponding address space of the sub-receiving address space 411(n−1) to the n-th corresponding address space of the sub-transmitting address space 412(n), respectively.

The sub control circuit 41(k) (k is 1 to n) performs the writing into the k-th memory area 7c(k) of the memory 7c by performing the writing into the k-th corresponding address space of the sub-transmitting address space 412(k). The writing of data into the k-th corresponding address space of the sub-transmitting address space 412(k) by the sub-control circuit 41(k) creates the effect as if the data were directly written into the k-th memory area 7c(k) of the memory 7c. Also, the sub-control circuit 41(k) performs reading out from the k-th memory area of the memory 7c directly by performing reading out from the k-th corresponding address space of the sub-transmitting address space 412(k). The reading out of the data from the k-th corresponding address space of the sub-transmitting address space 412(k) by the sub-control circuit 41(k) creates the effect as if the data were directly read out from the k-th memory area 7c(k) of the memory 7c.

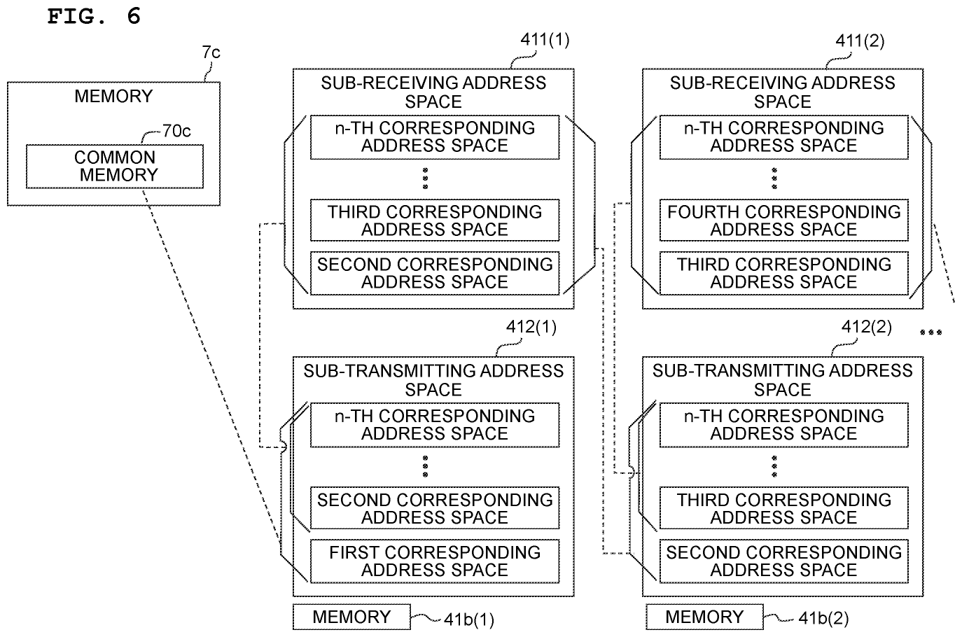

In the following, “writing of data into a common memory of a controller and reading of data out from the common memory of the controller, via a communication address space of a sub-control circuit” will be described. FIG. 6 is an explanatory diagram illustrating a relationship among a memory 7c of the main control circuit 7a, the sub-receiving address spaces 411 and the sub-transmitting address spaces 412, related to the writing of the data into the common memory of the controller and the reading of the data out from the common memory of the controller, via the communication address space of the sub-control circuit. The memory 7c includes a common memory 70c. The common memory 70c stores, for example, a parameter common to each of the head modules 40 (a common parameter).

The sub-control circuit 41(1) reserves the first corresponding address space to the n-th corresponding address space in the sub-transmitting address space 412(1). The sub-control circuit 41(1) reserves the second corresponding address space to the n-th corresponding address space in the sub-receiving address space 411(1).

The sub-control circuit 41(2) reserves the second corresponding address space to the n-th corresponding address space in the sub transmitting address space 412(2). The sub-control circuit 41(2) reserves the third corresponding address space to the n-th corresponding address space in the sub-receiving address space 411(2).

That is, the sub-control circuit 41(k) (k is 1 to n−1) reserves the k-th corresponding address space to the n-th corresponding address space in the sub-transmitting address space 412(k). The sub-control circuit 41(k) reserves the (k+1)-th corresponding address space to the n-th corresponding address space in the sub-receiving address space 411(k). The sub-control circuit 41(n) reserves the n-th corresponding address space in the sub-transmitting address space 412(n).

The main control circuit 7a and the sub-control circuit 41(1) correlate the common memory 70c with the first corresponding address space to the n-th corresponding address space of the sub-transmitting address space 412(1). That is, the main control circuit 7a and the sub-control circuit 41(1) assign the address of the common memory 70c to the first corresponding address space to the n-th corresponding address space of the sub-transmitting address space 412(1). The sub-control circuit 41(1) correlates the second corresponding address space to the n-th corresponding address space of the sub-transmitting address space 412(1) with the second corresponding address space to the n-th corresponding address space of the sub-receiving address space 411(1). That is, the sub-control circuit 41(1) assigns the addresses of the second corresponding address space to the n-th corresponding address space of the sub-transmitting address space 412(1) to the second corresponding address space to the n-th corresponding address space of the sub-receiving address space 411(1), respectively.

The sub-control circuit 41(1) and the sub-control circuit 41(2) correlate the second corresponding address space to the n-th corresponding address space of the sub-receiving address space 411(1) with the second corresponding address space to the n-th corresponding address space of the sub-transmitting address space 412(2). That is, the sub-control circuit 41(1) and the sub-control circuit 41(2) assign the addresses of the second corresponding address space to the n-th corresponding address space of the sub-receiving address space 411(1) to the second corresponding address space to the n-th corresponding address space of the sub-transmitting address space 412(2), respectively. The sub-control circuit 41(2) correlates the third corresponding address space to the n-th corresponding address space of the sub-receiving address space 411(2) with the third corresponding address space to the n-th corresponding address space of the sub-transmitting address space 412(2). That is, the sub-control circuit 41(2) assigns the address of the third corresponding address space to the n-th corresponding address space of the sub-transmitting address space 412(2) to the third corresponding address space to the n-th corresponding address space of the sub-receiving address space 411(2), respectively.

That is, the sub-control circuit 41(k) and the sub-control circuit 41(k+1) (k is 1 to n−2) correlate the (k+1)-th corresponding address space to the n-th corresponding address space in the sub-receiving address space 411(k) with the (k+1)-th corresponding address space to the n-th corresponding address space in the sub-transmitting address space 412(k+1). That is, the sub-control circuit 41(k) and the sub-control circuit 41(k+1) assign the addresses of the (k+1)-th corresponding address space to the n-th corresponding address space of the sub-receiving address space 411(k) to the (k+1)-th corresponding address space to the n-the corresponding address space of the sub-transmitting address space 412(k+1), respectively. The sub-control circuit 41(k+1) correlates the (k+2)-th corresponding address space to the n-th corresponding address space of the sub-receiving address space 411(k+1) with the (k+2)-th corresponding address space to the n-th corresponding address space of the sub-transmitting address space 412 (k+1). That is, the sub-control circuit 41(k+1) assigns the addresses of the (k+2)-th corresponding address space to the n-th corresponding address space of the sub-transmitting address space 412(k+1) to the (k+2)-th corresponding address space to the n-th corresponding address space of the sub-receiving address space 411(2), respectively.

The sub-control circuit 41(n−1) and the sub-control circuit 41(n) correlates the n-th corresponding address space of the sub-receiving address space 411(n−1) with the n-th corresponding address space of the sub-transmitting address space 412(n). That is, the sub-control circuit 41(n−1) and the sub-control circuit 41(n) assign the address of the n-th corresponding address space of the sub-receiving address space 411(n−1) to the n-th corresponding address space of the sub-transmitting address space 412(n).

The sub-control circuit 41(k) (k is 1 to n) performs writing into the common memory 70c by performing writing into the k-th corresponding address space of the sub-transmitting address space 412(k). The sub-control circuit 41(k) performs reading out from the common memory 70c by performing reading out from the k-th corresponding address space of the sub-transmitting address space 412(k). The sub-control circuit 41(k) can write a common parameter into the common memory 70c by, for example, writing the common parameter into the k-th corresponding address space. The sub-control circuit 41(k) can read out the common parameter written into the common memory 70c by, for example, reading out the common parameter written into the k-th corresponding address space.

Specifically, the main control circuit 7a and the sub-control circuit 41(1) correlates the common memory 70c with the third corresponding address space of the sub-transmitting address space 412(1). The sub-control circuit 41(1) and the sub-control circuit 41(2) correlates the third corresponding address space of the sub-receiving address space 411(1) with the third corresponding address space of the sub-transmitting address space 412(2). The sub-control circuit 41(2) and the sub-control circuit 41(3) correlates the third corresponding address space of the sub-receiving address space 411(2) with the third corresponding address space of the sub-transmitting address space 412(3). Thus, the common memory 70c is correlated with the sub-transmitting address space 412(3). Since the common memory 70c is correlated with the sub-transmitting address space 412(3), in a case that the sub-control circuit 41(3) writes data into the third corresponding address space of the sub-transmitting address space 412(3), the sub-control circuit 41(2) writes the data written into the third corresponding address space of the sub-transmitting address space 412(3) into the third corresponding address space of the sub-receiving address space 411(2) and the third corresponding address space of the sub-transmitting address space 412(2), the sub-control circuit 41(1) writes the data written into the third corresponding address space of the sub-transmitting address space 412(3) into the third corresponding address space of the sub-receiving address space 411(1) and the third corresponding address space of the sub-transmitting address space 412(1), and the main control circuit 7a writes the data written into the third corresponding address space of the sub-transmitting address space 412(3) into the common memory 70c . Therefore, by writing the data into the third address space of the sub-transmitting address space 412(3), the data is written into the common memory 70c.

The main control circuit 7a and the sub-control circuit 41(1) correlate the common memory 70c with the second corresponding address space of the sub-transmitting address space 412(1), and the sub-control circuit 41(1) and the sub-control circuit 41(2) correlate the second corresponding address space of the sub-receiving address space 411(1) with the second corresponding address space of the sub-transmitting address space 412(2). Thus, the common memory 70c is correlated with the sub-transmitting address space 412(2). Since the common memory 70c is correlated with the sub-transmitting address space 412(2), in a case that the sub-control circuit 41(2) writes data into the second corresponding address space of the sub-transmitting address space 412(2), the sub-control circuit 41(1) writes the data written into the second corresponding address space of the sub-transmitting address space 412(2) into the second corresponding address space of the sub-receiving address space 411(1) and the second corresponding address space of the sub-transmitting address space 412(1), and the main control circuit 7a writes the data written into the second corresponding address space of the sub-transmitting address space 412(2) into the main memory 70c . Therefore, the writing into the common memory 70c is performed by writing the data into the second corresponding address space of the sub-transmitting address space 412(2).

The main control circuit 7a and the sub-control circuit 41(1) correlate the common memory 70c with the first corresponding address space of the sub-transmitting address space 412(1). Since the common memory 70c is correlated with the sub-transmitting address space 412(1), in a case that the sub-control circuit 41(1) writes data into the first corresponding address space of the sub-transmitting address space 412(1), the main control circuit 7a writes the data written into the first corresponding address space of the sub-transmitting address space 412(1) into the common memory 70c. The wiring into the common memory 70c is performed by performing the writing of the data into the first corresponding address space of the sub-transmitting address space 412(1).

The sub control circuit 41(1) can read the common parameter written into the common memory 70c by reading out the common parameter written into the first corresponding address space of the sub-transmitting address space 412(1). The sub-control circuit 41(2) can read out the common parameter written into the common memory 70c by reading out the common parameter written into the second corresponding address space of the sub-transmitting address space 412(2). The sub-control circuit 41(3) can read out the common parameter written into the common memory 70c by reading out the common parameter written into the third corresponding address space of the sub-transmitting address space 412(3).

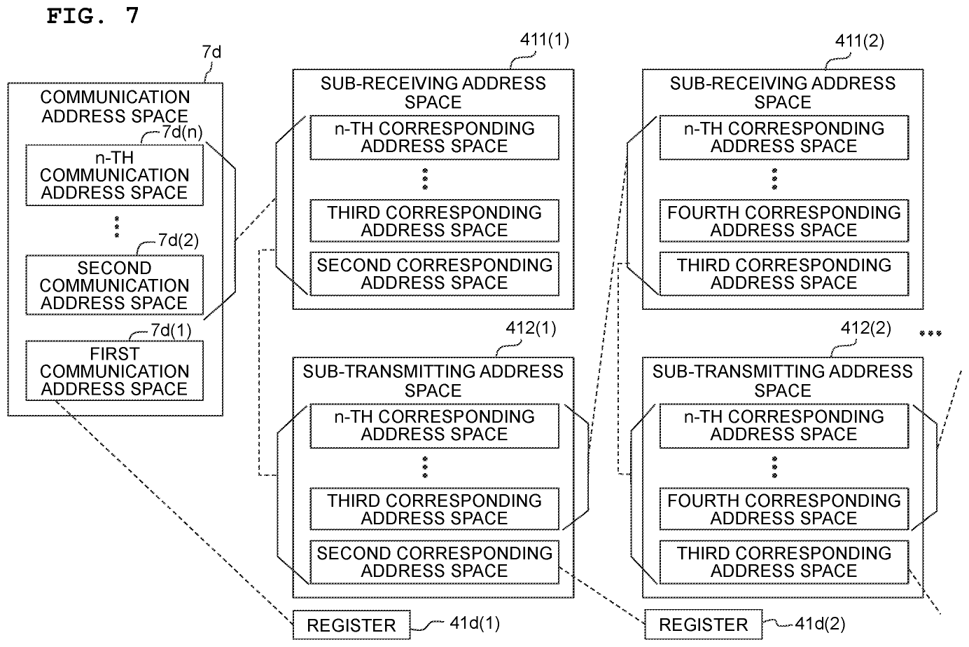

In the following, “writing of data into a register of a sub-control circuit” will be described. FIG. 7 is an explanatory diagram illustrating a relationship among the communication address space 7d, and the sub-receiving address spaces 411, the sub-transmitting address spaces 412, and the registers 41d (first to third registers) of the sub-control circuits 41, related to the writing of the data into the register of the sub-control circuit. The sub-control circuits 41 include the registers 41d. Hereinafter, the registers of the sub-control circuits 41(1) to 41(n) are also referred to as registers 41d(1) to 41d(n) (first to third sub-registers). Data related to control signals corresponding to the head modules 40(1) to 40(n) are stored in the registers 41d(1) to 41d(n), respectively, for example. The data related to the control signal is data different from the common parameter.

Like “the writing of the data into the memory of the sub-control circuit” described above, the sub control circuit 41(k) (k is 1 to n−1) reserves the (k+1)-th corresponding address space to the n-th corresponding address space corresponding to the (k+1)-th communication address space 7d(k+1) to the n-th communication address space 7d(n) in the sub-receiving address space 411(k). The sub-control circuit 41(k) reserves the (k+1)-th corresponding address space to the n-th corresponding address space corresponding to the (k+1)-th communication address space 7d(k+1) to the n-th communication address space 7d(n), in the sub-transmitting address space 412(k+1).

The main control circuit 7a and the sub-control circuit 41(1) correlate the first communication address space 7d(1) with the register 41d(1). That is, the main control circuit 7a and the sub-control circuit 41(1) assign the address of the first communication address space 7d(1) to the register 41d(1). The main control circuit 7a and the sub-control circuit 41(1) correlate the second communication address space 7d(2) to the n-th communication address space 7d(n) with the second corresponding address space to the n-th corresponding address space of the sub-receiving address space 411(1), respectively. That is, the main control circuit 7a and the sub-control circuit 41(1) assign the addresses of the second communication address space 7d(2) to the n-th communication address space 7d(n) to the second corresponding address space to the n-th corresponding address space of the sub-receiving address space 411(1), respectively. The sub-control circuit 41(1) correlates the second corresponding address space to the n-th corresponding address space of the sub-receiving address space 411(1) with the second corresponding address space to the n-th corresponding address space of the sub-transmitting address space 412(1). That is, the sub-control circuit 41(1) assigns the addresses of the second corresponding address space to the n-th corresponding address space of the sub-receiving address space 411(1) to the second corresponding address space to the n-th corresponding address space of the sub-transmit address space 412(1), respectively.

The sub-control circuit 41(1) and the sub-control circuit 41(2) correlate the second corresponding address space of the sub-transmitting address space 412(1) with the register 41d(2). That is, the sub-control circuit 41(1) and the sub-control circuit 41(2) assign the address of the second corresponding address space of the sub-transmitting address space 412(1) to the register 41d(2). The sub-control circuit 41(1) and the sub-control circuit 41(2) correlate the third corresponding address space to the n-th corresponding address space of the sub-transmitting address space 412(1) with the third corresponding address space to the n-th corresponding address space of the sub-receiving address space 411(2), respectively. That is, the sub-control circuit 41(1) and the sub-control circuit 41(2) assign the addresses of the third corresponding address space to the n-th corresponding address space of the sub-transmitting address space 412(1) to the third corresponding address space to the n-th corresponding address space of the sub-receiving address space 411(2), respectively.

That is, the sub-control circuit 41(k) and the sub-control circuit 41(k+1) (k is 1 to n−2) correlate the (k+1)-th corresponding address space of the sub-transmitting address space 412(k) with the register 41d(k+1). That is, the sub-control circuit 41(k) and the sub-control circuit 41(k+1) assign the address of the (k+1)-th corresponding address space of the sub-transmitting address space 412(k) to the register 41d (k+1). The sub-control circuit 41(k) and the sub-control circuit 41(k+1) correlate the (k+2)-th corresponding address space to the n-th corresponding address space of the sub-transmitting address space 412(k) with the (k+2)-th corresponding address space to the n-th corresponding address space of the sub-receiving address space 411(k+1). That is, the sub-control circuit 41(k) and the sub-control circuit 41(k+1) assign the addresses of the (k+2)-th corresponding address space to the n-th corresponding address space of the sub-transmitting address space 412(k) to the (k+2)-th corresponding address space to the n-th corresponding address space of the sub-receiving address space 411(k+1), respectively.

The sub-control circuit 41(n−1) and the sub-control circuit 41(n) correlate the n-th corresponding address space of the sub-transmitting address space 412(n−1) with the register 41d(n). That is, the sub-control circuit 41(n−1) and the sub-control circuit 41(n) assign the address of the n-th corresponding address space of the sub-transmitting address space 412(n−1) to the register 41d(n). In other words, the first communication address space 7d(1) to the n-th communication address spaces 7d(n) of the main control circuit 7a are correlated with the register 41d(1) to the register 41d(n) of the sub-control circuit 41(1) to the sub-control circuit 41(n), respectively.

Since the k-th communication address space 7d(k) and the register 41d(k) are correlated with each other, the sub-control circuit 41(k) writes data written into the k-th communication address space 7d(k) into the register 41d(k), without adding a header to the data to describe the destination of the data, and without checking the destination described in the header. That is, the writing of the data into the k-th communication address space 7d(k) performed by the controller 7b creates the effect as if the data were written directly into the register 41d(k).

Specifically, the main control circuit 7a and the sub-control circuit 41(1) correlate the second communication address space 7d(2) with the second corresponding address space of the sub-receiving address space 411(1). The sub-control circuit 41(1) correlates the second corresponding address space of the sub-receiving address space 411(1) with the second corresponding address space of the sub-transmitting address space 412(1). The sub-control circuit 41(1) and the sub-control circuit 41(2) correlate the second corresponding address space of the sub-transmitting address space 412(1) with the register 41d(2). Thus, the second communication address space 7d(2) is correlated with the register 41d(2). Since the second communication address space 7d(2) and the register 41d(2) are correlated with each other, in a case that the main control circuit 7a writes data related to the control signal into the second communication address space 7d(2), the sub-control circuit 41(1) writes the data related to the control signals into the second corresponding address space of the sub-receiving address space 411(1) and the second corresponding address space of the sub-transmitting address space 412 (1), and the sub-control circuit 41(2) writes the data related to the control signal into the register 41d(2).

In addition, the main control circuit 7a and the sub-control circuit 41(1) correlate the third communication address space 7d(3) with the third corresponding address space of the sub-receiving address space 411(1). The sub-control circuit 41(1) correlates the third corresponding address space of the sub-receiving address space 411(1) with the third corresponding address space of the sub-transmitting address space 412(1). The sub-control circuit 41(1) and the sub-control circuit 41(2) correlate the third-corresponding address space of the sub-transmitting address space 412(1) with the third-corresponding address space of the sub-receiving address space 411(2). The sub-control circuit 41(2) correlates the third corresponding address space of the sub-receiving address space 411(2) with the third corresponding address space of the sub-transmitting address space 412(2). The sub-control circuit 41(2) and sub-control circuit 41(3) correlate the third corresponding address space of the sub-transmitting address space 412(2) with the register 41d(3). Thus, the third communication address space 7d(3) and the register 41d (3) are correlated with each other. In a case that the main control circuit 7a writes data related to the control signal into the third communication address space 7d(2), the sub-control circuit 41(1) writes data related to the control signal into the third corresponding address space of the sub-receiving address space 411(1) and the third corresponding address space of the sub-transmitting address space 412(1), and the sub-control circuit 41(2) writes the data related to the control signals into the third corresponding address space of the sub-receiving address space 411(2) and the third corresponding address space of the sub-transmitting address space 412(2), and the sub-control circuit 41(3) writes the data related to the control signals into the register 41d(3).

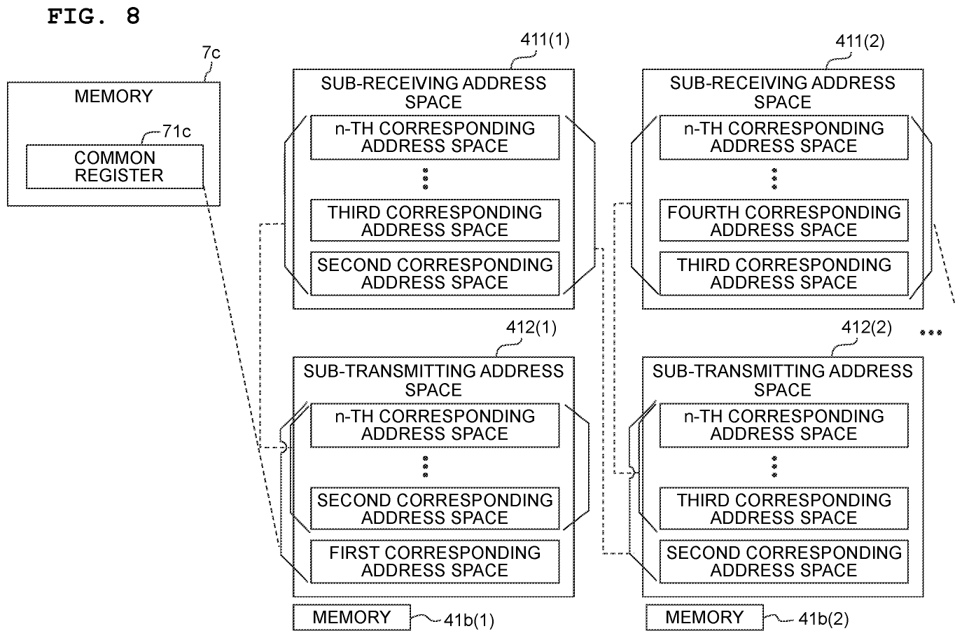

In the following, “writing of data into a register of a controller and reading of data out from the register via a communication address space of a sub-control circuit” will be described. FIG. 8 is an explanatory diagram illustrating a relationship between the memory 7c of the main control circuit 7a, the sub-receiving address spaces 411 and the sub-transmitting address spaces 412, related to the writing of the data into the register of the controller and the reading of the data out from the register via the communication address space of the sub-control circuit. The memory 7c includes a common register 71c. For example, any of the head modules 40 stores data in the common register 71c. The control unit 7b notifies the other head module(s) 40 (that is, head module(s) different from the head module 40 that stored the data in the common register 71c) that the data has been stored in the common register 71c. The other head module(s) 40 accesses the common register 71c and reads out the data.

Like “the writing of the data into the common memory of the controller and the reading of the data out from the common memory via the communication address space of the sub-control circuit” described above, the sub-control circuit 41(k) (k is 1 to n−1) reserves the k-th corresponding address space to the n-th corresponding address space in the sub-transmitting address space 412(k). The sub control circuit 41(k) reserves the (k+1)-th corresponding address space to the n-th corresponding address space in the sub-receiving address space 411(k). The sub-control circuit 41(n) reserves the n-th corresponding address space in the sub-transmitting address space 412(n).

The main control circuit 7a and the sub-control circuit 41(1) correlate the common register 71c with the first corresponding address space to the n-th corresponding address space of the sub-transmitting address space 412(1). That is, the main control circuit 7a and the sub-control circuit 41(1) assign the address of the common register 71c to the first corresponding address space to the n-th corresponding address space of the sub-transmitting address space 412(1). The sub-control circuit 41(1) correlate the second corresponding address space to the n-th corresponding address space of the sub-transmitting address space 412(1) with the second corresponding address space to the n-th corresponding address space of the sub-receiving address space 411(1). That is, the sub-control circuit 41(1) assigns the addresses of the second corresponding address space to the n-th corresponding address space of the sub-transmitting address space 412(1) to the second corresponding address space to the n-th corresponding address space of the sub-receiving address space 411(1), respectively.

The sub-control circuit 41(1) and the sub-control circuit 41(2) correlate the second corresponding address space to the n-th corresponding address space of the sub-receiving address space 411(1) with the second corresponding address space to the n-th corresponding address space of the sub-transmitting address space 412(2). That is, the sub-control circuit 41(1) and the sub-control circuit 41(2) assign the addresses of the second corresponding address space to the n-th corresponding address space of the sub-receiving address space 411(1) to the second corresponding address space to the n-th corresponding address space of the sub-transmitting address space 412(2), respectively. The sub-control circuit 41(2) correlates the third corresponding address space to the n-th corresponding address space of the sub-receiving address space 411(2) with the third corresponding address space to the n-th corresponding address space of the sub-transmitting address space 412(2). That is, the sub-control circuit 41(2) assigns the address of the third corresponding address space to the n-th corresponding address space of the sub-transmitting address space 412(2) to the third corresponding address space to the n-th corresponding address space of the sub-receiving address space 411(2), respectively.

That is, the sub-control circuit 41(k) and the sub-control circuit 41(k+1) (k is 1 to n−2) correlate the (k+1)-th corresponding address space to the n-th corresponding address space in the sub-receiving address space 411(k) with the (k+1)-th corresponding address space to the n-th corresponding address space in the sub-transmitting address space 412(k+1). That is, the sub-control circuit 41(k) and the sub-control circuit 41(k+1) assign the addresses of the (k+1)-th corresponding address space to the n-the corresponding address space of the sub-receiving address space 411(k) to the (k+1)-th corresponding address space to the n-the corresponding address space of the sub-transmitting address space 412(k+1), respectively. The sub-control circuit 41(k+1) correlates the (k+2)-th corresponding address space to the n-th corresponding address space of the sub-receiving address space 411(k+1) with the (k+2)-th corresponding address space to the n-th corresponding address space of the sub-transmitting address space 412(k+1). That is, the sub-control circuit 41(k+1) assigns the addresses of the (k+2)-th corresponding address space to the n-th corresponding address space of the sub-transmitting address space 412(k+1) to the (k+2)-th corresponding address space to the n-th corresponding address space of the sub-receiving address space 411(2), respectively.

The sub-control circuit 41(n−1) and the sub-control circuit 41(n) correlate the n-th corresponding address space of the sub-receiving address space 411(n−1) with the n-th corresponding address space of the sub-transmitting address space 412(n). That is, the sub-control circuit 41(n−1) and the sub-control circuit 41(n) assign the address of the n-th corresponding address space of the sub-receiving address space 411(n−1) to the n-th corresponding address space of the sub-transmitting address space 412(n).

The sub-control circuit 41(k) (k is 1 to n) performs writing into the common register 71c by performing writing into the k-th corresponding address space of the sub-transmitting address space 412(k). The sub-control circuit 41(k) performs reading out from the common register 71c by performing reading out from the k-th corresponding address space of the sub-transmitting address space 412(k). The sub control circuit 41(k) can write data into the common register 71c by writing data into the k-th corresponding address space, for example. The writing of data into the k-th corresponding address space by the sub-control circuit 41(k) creates an effect as if the data were directly written into the common register 71c. The sub-control circuit 41(k) can read the data written into the common register 71c by reading out the data written into the k-th corresponding address space, for example. The reading of data out from the k-th corresponding address space by the sub-control circuit 41(k) creates an effect as if the data were directly read out from the common register 71c.

Specifically, the main control circuit 7a and the sub-control circuit 41(1) correlate the common register 71c with the first corresponding address space of the sub-transmitting address space 412(1). That is, the common register 71c and the sub control circuit 41(1) are correlated with each other. Therefore, the data written by the sub-control circuit 41(1) into the first corresponding address space of the sub-transmitting address space 412(1) is written into the common register 71c. The sub-control circuit 41(1) performs reading out from the common register 71c by performing reading out from the first corresponding address space of the sub-transmitting address space 412(1).

In addition, the main control circuit 7a and the sub-control circuit 41(1) correlate the common register 71c with the second corresponding address space of the sub-transmitting address space 412(1). The sub-control circuit 41(1) correlates the second corresponding address space of the sub-transmitting address space 412(1) with the second corresponding address space of the sub-receiving address space 411(1). The sub-control circuit 41(1) and sub-control circuit 41(2) correlate the second corresponding address space of the sub-receiving address space 411(1) with the second corresponding address space of the sub-transmitting address space 412(2). Thus, the common register 71c and the sub-control circuit 41(2) are correlated with each other. Therefore, data written by the sub-control circuit 41(2) into the second corresponding address space of the sub-transmitting address space 412(2) is written into the second corresponding address space of the sub-receiving address space 411(1), and then written into the second corresponding address space of the sub-transmission address space 412(1), and then written into the common register 71c. The sub-control circuit 41(2) performs reading out from the common register 71c by performing reading out from the second corresponding address space of the sub transmitting address space 412(2).

Specifically, the main control circuit 7a and the sub-control circuit 41(1) correlate the common register 71c with the third corresponding address space of the sub-transmitting address space 412(1). The sub-control circuit 41(1) correlate the third corresponding address space of the sub-transmitting address space 412(1) with the third corresponding address space of the sub-receiving address space 411(1). The sub-control circuit 41(1) and the sub-control circuit 41(2) correlate the third-corresponding address space of the sub-receiving address space 411(1) with the third-corresponding address space of the sub-transmitting address space 412(2). The sub-control circuit 41(2) correlate the third-corresponding address space of the sub-transmitting address space 412(2) and the third corresponding address space of the sub-receiving address space 411(2). The control circuit 41(2) and sub-control circuit 41(3) correlate the third corresponding address space of the sub-receiving address space 411(2) and the third corresponding address space of the sub-transmitting address space 412(3). Thus, the common register 71c and the third corresponding address space of the sub-transmitting address space 412(3) are correlated with each other. Therefore, data written by the sub-control circuit 41(3) into the third corresponding address space of the sub-transmitting address space 412(3) is written into the third corresponding address space of the sub-receiving address space 411(2), and then into the third corresponding address space of the sub-transmitting address space 412(2), and then into the third corresponding address space of the sub-receiving address space 411(1), and then into the third corresponding address space of the sub-transmitting address space 412(1), and then into the common register 71c. The sub control circuit 41(3) performs reading out from the common register 71c by performing reading out from the third corresponding address space of the sub-transmitting address space 412(3).

In the embodiment, the sub-control circuit 41(k) may not include the register 41d(k).

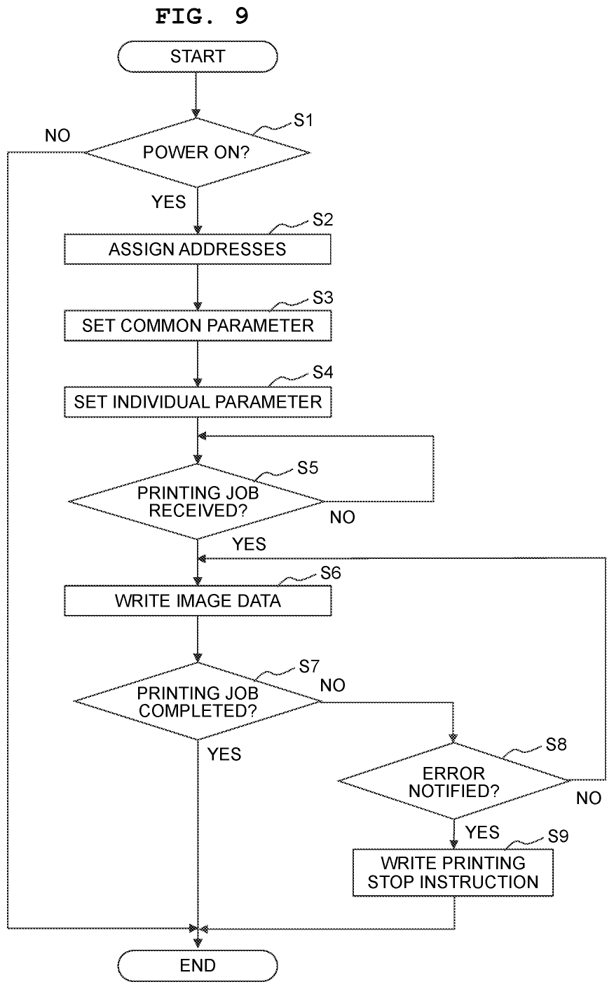

In the following, a printing process performed by the printing apparatus 1 will be described. FIG. 9 is a flowchart illustrating the printing process performed by the main control circuit 7a. For example, the printing process depicted in the flowchart can be executed by the printing apparatus 1 when the printing apparatus 1 is in a state that power is saved (that is, in a power-saving mode, etc.).

The control unit 7b determines whether or not the power has been turned on (S1). That is, the control unit 7b determines whether or not the printing apparatus 1 has been started up. In a case that the control unit 7b determines that the power has not been turned on (S1: NO), the control unit 7b terminates the process. In a case that the control unit 7b determines that the power has been turned on (S1: YES), the control unit 7b executes assignment of the addresses to the communication address space 7d, the sub-receiving address spaces 411, the sub-transmitting address spaces 412, the memory 7c, the common memory 70c and the common register 71c, etc. (S2).

The control unit 7b sets the common parameter to each of the head modules 40(1) to the head module 40(n) (S3). For example, as described in “the writing of the data into the register of the sub-control circuit” (see FIG. 7), the control unit 7b can write the common parameter into the register 41d (k) by writing the common parameter into the k-th communication address space 7d (k) (k is a natural number from 1 to n). Then, the sub-control circuit 41(k) reads the common parameter out from the register 41d(k). An example of the common parameter is information indicating whether the printing is color printing or monochrome printing.

The control unit 7b sets the individual parameter to each of the head module 40(1) to the head module 40(n) (S4). The individual parameter is a parameter specific to each of the head module 40(1) to the head module 40(n), and a parameter to be individually set to each of the head module 40(1) to the head module 40(n). An example of the individual parameter is the drive waveform for driving the head 42. This is because the drive waveform for driving the head 42 varies depending on the characteristics of each of the head modules 40. For example, as described in “the writing of the data into the register of the sub-control circuit” (see FIG. 7), the control unit 7b can write the individual parameter into the register 41d(k) by writing the individual parameter into the k-th communication address space 7d(k) (k is a natural number from 1 to n). The sub-control circuit 41(k) then reads out the individual parameter from the register 41d(k).

The control unit 7b determines whether or not a printing job has been received from the external device 9 (S5). In a case that the control unit 7d determines that the printing job has not been received (S5: NO), the control unit 7b returns the process to the step S5. In a case that the control unit 7b determines that the print job has been received (S5: YES), the control unit 7b writes the image data into each memory 41b(k) (k is a natural number from 1 to n) (S6). For example, as described in “the writing of the data into the memory of the sub-control circuit” (see, FIG. 4), the control unit 7b can write the image data into the memory 41b (k) by writing the k-th data (the image data) into the k-th communication address space 7d(k) (k is a natural number from 1 to n).

The control circuit 7b determines whether the print job has been completed or not (S7). In a case that the printing by each head 42 has been completed based on the image data written into each memory 41b(k), each sub-control circuit 41(k) notifies the main control circuit 7a that the printing has been completed. In a case that the control unit 7b receives the notification from each sub-control circuit 41(k), the control unit 7b determines that the printing job has been completed. In a case that the control unit 7b determines that the printing job has been completed (S7: YES), the control unit 7b terminates the process.

In a case that the control unit 7b determines that the printing job has not been completed (S7: NO), the control unit 7b determines whether or not an error notification has been received from any of the sub-control circuits 41 (S8). In a case that the control unit 7b determines that no error notification has been received (S8: NO), the control unit 7b returns the process to the step S6. In a case that the control unit 7b determines that the error notification has been received (S8: YES), the control unit 7b writes a printing stop instruction into each of the register 41d(k) (S9).

For example, as described in “the writing of the data into the register of the sub-control circuit” (see FIG. 7), the control unit 7b can write the printing stop instruction into the register 41d(k) by writing the printing stop instruction into the k-th communication address space 7d(k). The control unit 7b terminates the process, after the control unit 7b writes the printing stop instruction into each register 41d (k).

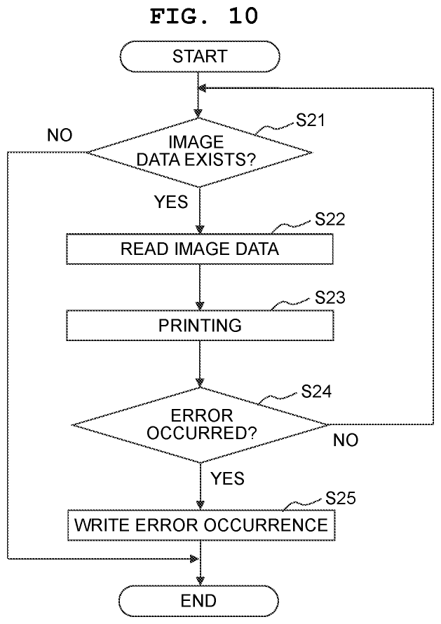

FIG. 10 is a flowchart illustrating the printing process performed by the sub-control circuit 41(k). The control unit 41a determines whether or not the image data has been written into the memory 41b (S21). In a case that the control unit 41a determines that no image data has been written into the memory 41b (S21: NO), the control unit 41a terminates the process. In a case that the control unit 41a determines that the image data has been written into the memory 41b (S21: YES), the control unit 41a reads the image data out from the memory 41b (S22), and executes the printing by driving the head 42 (S23). In a case that the control unit 7b stops the writing of the image data into each memory 41b(k) (k is a natural number from 1 to n), the control unit 41a determines that the image data has not been written into memory 41b (S21: NO), and the control unit 41a terminates the printing.

The control unit 41a determines whether or not an error has been occurred in the sub-control circuit 41(k) (S24). In a case that no error has been occurred (S24: NO), the control unit 41a returns the process to the step S21. In a case that an error has been occurred (S24: YES), the control unit 41a writes the error occurrence information into the k-th corresponding address space of the sub-transmitting address space 412(k) (S25), and terminates the process. For example, as described in “the writing of the data into the register of the controller and the reading of the data out from the register via the communication address space of the sub-control circuit” (see FIG. 8), the error occurrence information written into the k-th corresponding address space of the sub-transmitting address space 412(k) is written into the common register 71c.

In a case that the error occurrence information has been written into the common register 71c, in the step S8 of FIG. 9, the control unit 7b determines that an error notification has been received (S8: YES), and the control unit 7b writes the printing stop instruction into each register 41d (k) (S9). In a case that the control unit 41a of each sub-control circuit 41(k) reads the printing stop instruction out from each register 41d(k), the control unit 41a stops the printing.

In the following, a first modification of the printing process will be described. In the first modification of the printing process, a dedicated line for transmitting an interrupt signal is connected between the main control circuit 7a and the sub-control circuit 41(1), and between the sub-control circuit 41(k) and the sub-control circuit 41(k+1) (k is 1 to n−1). That is, the main control circuit 7a and the sub-control circuit 41(1) to the sub-control circuit 41(n) are connected by the dedicated line in series.

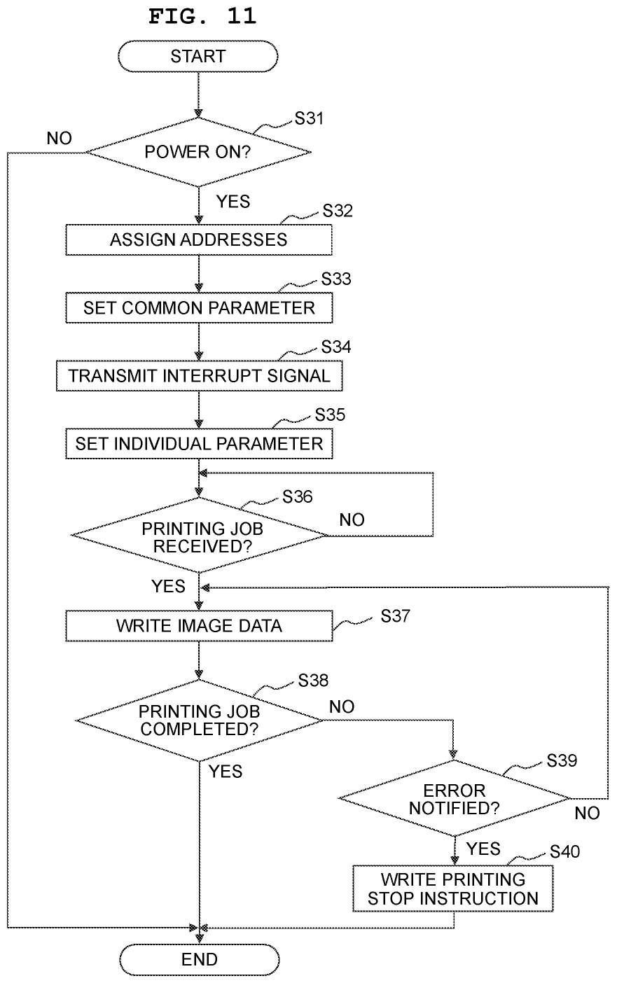

FIG. 11 is a flowchart illustrating the printing process executed by the main control circuit 7a. The control unit 7b determines whether or not the power has been turned on (S31). That is, the control unit 7b determines whether or not the printing apparatus 1 has been started up. In a case that the control unit 7b determines that the power has not been turned on (S31: NO), the control unit 7b terminates the process. In a case that the control unit 7b determines that the power has been turned on (S31: YES), the control unit 7b executes assignment of the addresses to the communication address space 7d, the sub-receiving address spaces 411, the sub-transmitting address spaces 412, the memory 7c, the common memory 70c and the common register 71c, etc. (S32).

The control unit 7b sets the common parameter to each of the head modules 40(1) to the head module 40(n) (S33). For example, as described in “the writing of the data into the common memory of the controller and the reading of the data out from the common memory of the controller, via the communication address space of the sub-control circuit” (see FIG. 6), the control unit 7b can write the common parameter into the k-th corresponding address space of the sub-transmitting address space 412(k) by writing the common parameter into the common memory 70c (k is a natural number from 1 to n). An example of the common parameter is information indicating whether the printing is color printing or monochrome printing. The control unit 7b transmits an interrupt signal indicating that the common parameter has been set to each of the head modules 40 via the dedicated line (S34).

The control unit 7b sets an individual parameter to each of the head module 40 (1) to the head module 40(n) (S35). The individual parameter is a parameters to be set individually to each of the head module 40(1) to the head module 40(n). An example of the individual parameter is the driving waveforms for driving the head 42. This is because the drive waveform for driving the head 42 varies depending on the characteristics of each of the head modules 40. For example, as described in “the writing of the data into the register of the sub-control circuit” (see FIG. 7), the control unit 7b can write the individual parameter into the register 41d(k) by writing the individual parameter into the k-th communication address space 7d(k) (k is a natural number from 1 to n).

The control unit 7b determines whether or not a printing job has been received from the external device 9 (S36). In a case that the control unit 7b determines that the printing job has not been received (S36: NO), the control unit 7b returns the process to the step S36. In a case that the control unit 7b determines that the printing job has been received (S36: YES), the control unit 7b writes the image data into each of the memory 41b(k) (k is a natural number from 1 to n) (S37). For example, as described in “the writing of the data into the memory of the sub-control circuit” (see, FIG. 4), the control unit 7b can write the image data into the memory 41b(k) by writing the k-th data (the image data) into the k-th communication address space 7d(k) (k is a natural number from 1 to n).

The control circuit 7b determines whether or not the printing job has been completed (S38). In a case that the printing by each of the heads 42 is completed based on the image data written into each memory 41b(k), each sub-control circuit 41(k) notifies the main control circuit 7a that the printing has been completed. In a case that the control unit 7b receives the notification from each sub-control circuit 41(k), the control unit 7b determines that the printing job has been completed. In a case that the control unit 7b determines that the printing job has been complete (S38: YES), the control unit 7b terminates the process.

In a case that the control unit 7b determines that the printing job has not been completed (S38: NO), the control unit 7b determines whether or not an error notification has been received from any of the sub-control circuits 41 (S39). In a case that the control unit 7b determines that no error notification has been received (S39: NO), the control unit 7b returns the process to the step S37. In a case that the control unit 7b determines that the error notification has been received (S39: YES), the control unit 7b writes a printing stop instruction into each register 41d(k) (S40).

For example, as described in “the writing of the data into the register of the sub-control circuit” (see FIG. 7), the control unit 7b can write the printing stop instruction into the register 41d(k) by writing the printing stop instruction into the k-th communication address space 7d(k). The control unit 7b terminates the process, after the control unit 7b writes the printing stop instruction into each register 41d(k).

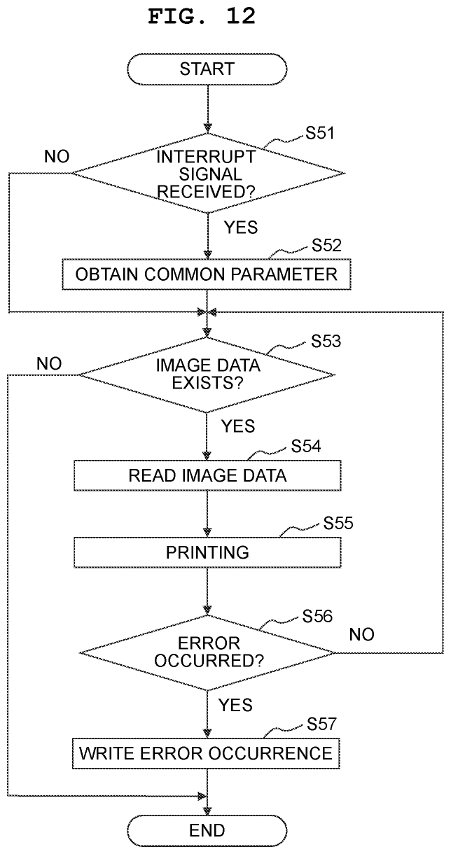

FIG. 12 is a flowchart illustrating the printing process executed by the sub-control circuit 41(k). The control unit 41a determines whether or not the interrupt signal has been received (S51). In a case that the control unit 41a determines that the interrupt signal has been received (S51: YES), the control unit 41a reads the common parameter out from the k-th corresponding address space of the sub-transmitting address space 412(k) (S52). The common parameter has been written into the k-th corresponding address space of the sub-transmitting address space 412(k) by the control unit 7b, in the step S33 described above.

After the processing of the step S52, or in a case that the control unit 41a determines that no interrupt signal has been received in the step S51 (S51: NO), the control unit 41a determines whether or not an image data has been written into the memory 41b (S53). In a case that the control unit 41a determines that no image data has been written into the memory 41b (S53: NO), the control unit 41a terminates the process. In a case that the control unit 41a determines that the image data has been written into the memory 41b (S53: YES), the control unit 41a reads the image data out from the memory 41b (S54), and executes the printing by driving the heads 42 (S55).

The control unit 41a determines whether or not an error has been occurred in the sub-control circuit 41(k) (S56). In a case that the control unit 41a determines that no error has been occurred (S56: NO), the control unit 41a returns the process to the step S53. In a case that the error has been occurred (S56: YES), the control unit 41a writes an error occurrence information into the k-th corresponding address space of the sub-transmitting address space 412(k) (S57), and terminates the process. For example, as described in “the writing of the data into the register of the controller and the reading of the data out from the register via the communication address space of the sub-control circuit” (see FIG. 8), the error occurrence information written into the k-th corresponding address space of the sub-transmitting address space 412(k) is written into the common register 71c.

In a case that the error occurrence information has been written into the common register 71c, the control unit 7b determines that an error notification bas been received (S39: YES) in the step S39 of FIG. 11, and the control unit 7b writes a printing stop instruction into each register 41d (k) (S40). In a case that the control unit 41a of each sub-control circuit 41(k) reads out the printing stop instruction from corresponding register 41d(k), the control unit 41a stops the printing.

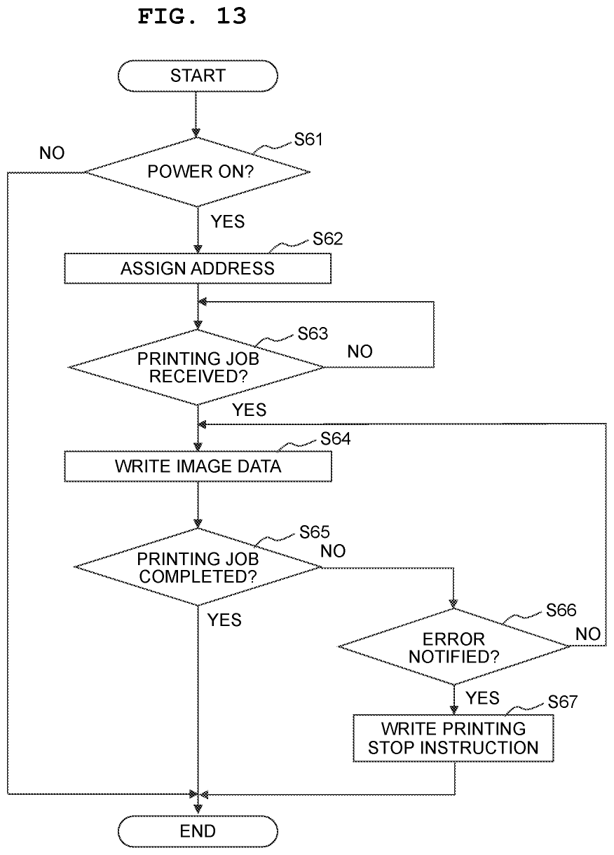

In the following, a second modification of the printing process will be described. FIG. 13 is a flowchart illustrating a printing process executed by the main control circuit 7a. Note that a common parameter and an individual parameter are written in advance into each of the first memory area 7c(1) to the n-th memory area 7c(n) of the memory 7c.

The control unit 7b determines whether or not the power has been turned on (S61). That is, the control unit 7b determines whether or not the printing apparatus 1 has been started up. In a case that the control unit 7b determines that the power has not been turned on (S61: NO), the control unit 7b terminates the process. In a case that the control unit 7b determines that the power has been turned on (S61: YES), the control unit 7b executes assignment of addresses to the communication address space 7d, the sub-receiving address spaces 411, the sub-transmitting address spaces 412, the memory 7c, the common memory 70c , and the common register 71c, etc. (S62).

The control unit 7b determines whether or not a printing job has been received from the external device 9 (S63). In a case that the control unit 7b determines that the printing job has not been received (S63: NO), the control unit 7b returns the process to the step S63. In a case that the control unit 7b determines that the printing job has been received (S63: YES), the control unit 7b writes an image data into each memory 41b(k) (k is a natural number from 1 to n) (S64). For example, as described in “the writing of the data into the memory of the sub-control circuit” (see, FIG. 4), the control unit 7b can write the image data into the memory 41b(k) by writing the k-th data (the image data) into the k-th communication address space 7d(k) (k is a natural number from 1 to n).

The control circuit 7b determines whether or not the printing job has been completed (S65). In a case that printing by each of the heads 42 has been completed based on the image data written into each memory 41b(k), each of the sub-control circuit 41(k) notifies the main control circuit 7a that the printing has been completed. In a case that the control unit 7b receives the notification from each sub-control circuit 41(k), the control unit 7b determines that the printing job has been completed. In a case that the control unit 7b determines that the printing job has been completed (S65: YES), the control unit 7b terminates the process.

In a case that the control unit 7b determines that the printing job has not been completed (S65: NO), the control unit 7b determines whether or not an error notification has been received from any of the sub-control circuits 41 (S66). In a case that the control unit 7a determines that no error notification has been received (S66: NO), the control unit 7b returns the process to the step S64. In a case that the control unit 7b determines that an error notification has been received (S66: YES), the control unit 7b writes a printing stop instruction into each register 41d(k) (S67).

For example, as described in “the writing of the data into the register of the sub-control circuit”, (see FIG. 7), the control unit 7b can write a printing stop instruction into the register 41d(k) by writing the printing stop instruction into the k-th communication address space 7d(k). The control unit 7b terminates the process, after the control unit 7b writes the printing stop instruction into each register 41d (k).

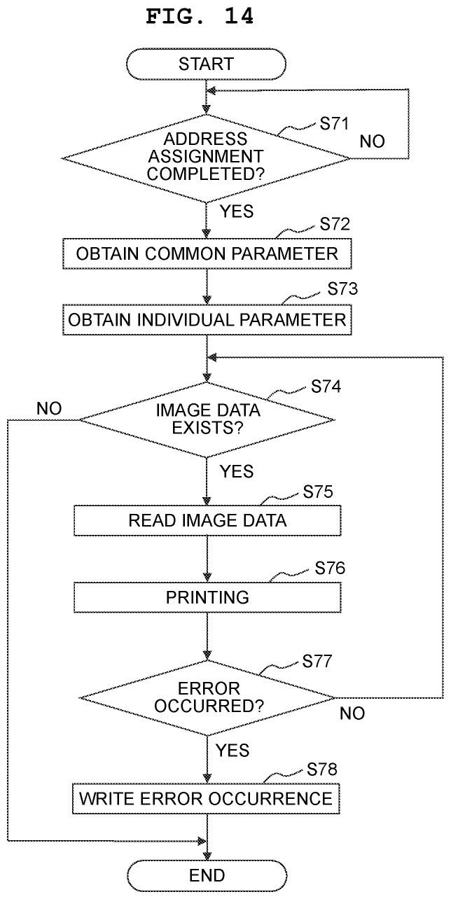

FIG. 14 is a flowchart illustrating the printing process executed by the sub-control circuit 41(k). The control unit 41a determines whether or not address assignment has been completed (S71). In a case that the control unit 41a determines that the address assignment has not been completed (S71: NO), the control unit 41a returns the process to the step S71. In a case that the control unit 41a determines that the address assignment has been completed (S71: YES), the control unit 41a obtains a common parameter (S72), and obtains an individual parameter (S73). For example, as described in “the writing of the data into the memory area of the controller and the reading out of the data from the memory area of the controller, via the communication address space of the sub-control circuit” (see FIG. 5), the control unit 41a reads out and obtains the common and individual parameters from the k-th corresponding address space in the sub-transmitting address space 412(k).

After the processing of the step S73, the control unit 41a determines whether or not the image data has been written into the memory 41b (S74). In a case that the control unit 41a determines that no image data has been written into the memory 41b (S74: NO), the control unit 41a terminates the process. In a case that the control unit 41a determines that the image data has been written into the memory 41b (S74: YES), the control unit 41a reads the image data out from the memory 41b (S75), and executes the printing by driving the heads 42 (S76).

The control unit 41a determines whether or not an error has been occurred in the sub-control circuit 41(k) (S77). In a case that the control unit 41a determines that no error has been occurred (S77: NO), the control unit 41a returns the process to the step S74. In a case that the error has been occurred (S77: YES), the control unit 41a writes error occurrence information into the k-th corresponding address space of the sub-transmitting address space 412(k) (S78), and terminates the process. For example, as described in “the writing of the data into the memory area of the controller and the reading out of the data from the memory area of the controller, via the communication address space of the sub-control circuit” (see FIG. 5), the error occurrence information written into the k-th corresponding address space of the sub-transmitting address space 412(k) is written into the k-th memory area 7c(k) of the memory 7c.

In a case that the error occurrence information has been written into the k-th memory area 7c(k) of the memory 7c, the control unit 7b determines that an error notification has been received (S66: YES) in the step S66 of FIG. 13, and the control unit 7b writes a printing stop instruction into the k-th memory area 7c(k) (S67). In a case that the control unit 41a of each sub-control circuit 41(k) reads out the printing stop instruction from corresponding k-th memory area 7c(k), the control unit 41a stops the printing.

The computer program can be arranged on a single computer, or in a single site. Alternatively, the computer program can be dispersed over a plurality of sites, and can be expanded such that the program will be executed on a plurality of computers mutually connected via a communication network.

The embodiments disclosed here should be considered exemplary in all respects and not restrictive. The scope of the invention is intended to include all modifications within the scope of the claims and the scope equivalent to the claims. The matters described in each embodiment can be combined with each other. Also, the independent and dependent claims recited in the claims can be combined with each other in all combinations, regardless of the form of citation.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing apparatus comprising:
a main control circuit;
a sub-control circuit group connected to the main control circuit in series, the sub-control circuit group being configured to transfer data from the main control circuit downstream; and
a head group configured to be driven by the sub-control circuit group based on the data, wherein:
the sub-control circuit group includes a first sub-control circuit connected to the main control circuit, and a second sub-control circuit positioned downstream of the first sub-control circuit;
the main control circuit is configured to reserve a main communication address space in the main control circuit;
the first sub-control circuit is configured to reserve a first sub-communication address space in the first sub-control circuit;
the first sub-control circuit includes a first sub-memory; and
the first sub-control circuit is configured to:
in a case that the data is written into a first main communication address space, write the data written into the first main communication address space into the first sub-memory, the first main communication address space being reserved in the main communication address space and being correlated with the first sub-memory; and
in a case that the data is written into a second main communication address space reserved in the main communication address space, write the data written into the second main communication address space into the first sub-communication address space.

2. The printing apparatus according to claim 1, wherein:
the second sub-control circuit includes a second sub-memory; and
in a case that the data is written into the second main communication address space correlated with the second sub-memory, the second sub-control circuit is configured to write the data written into the second main communication address space into the second sub-memory via the first sub-communication address space.

3. The printing apparatus according to claim 1, wherein:
the sub-control circuit group includes a third sub-control circuit positioned downstream of the second sub-control circuit;
the second sub-control circuit is configured to reserve a second sub-communication address space in the second sub-control circuit; and
in a case that the data is written into the third main communication address space reserved in the main communication address space, the second sub-control circuit is configured to write the data written into the third main communication address space into the second sub-communication address space.

4. The printing apparatus according to claim 3, wherein:
the third sub-control circuit includes a third sub-memory; and
in a case that the data is written into the third main communication address space correlated with the third sub-memory, the third sub-control circuit is configured to write the data written into the third main communication address space into the third sub-memory via the second sub-communication address space.

5. The printing apparatus according to claim 3, wherein:
the first sub-communication address space includes a first sub-receiving address space and a first sub-transmitting address space; and
the first sub-control circuit is configured to:
in a case that the data is written into the second main communication address space, write the data written into the second main communication address space into the first receiving space and the first transmitting space, the first receiving space being reserved in the first sub-receiving address space and being correlated with the second main communication address space, the first transmitting space being reserved in the first sub-transmitting address space and being correlated with the first receiving space; and
in a case that the data is written into the third main communication address space, write the data written into the third main communication address space into a second receiving space and the second transmitting space, the second receiving space being reserved in the first sub-receiving address space and being correlated with the third main communication address space, the second transmitting space being reserved in the first sub-transmitting address space and being correlated with the second receiving space.

6. The printing apparatus according to claim 5, wherein:
the second sub-communication address space includes a second sub-receiving address space and a second sub-transmitting address space; and
in a case that the data is written into the third main communication address space, the second sub-control circuit is configured to write the data written into the third main communication address space into the third receiving space and the third transmitting space, the third receiving space being reserved in the second sub-receiving address space and being correlated with the third main communication address space, the third transmitting space being reserved in the second sub-transmitting address space and being correlated with the third receiving space.

7. The printing apparatus according to claim 3, wherein:
the main control circuit includes a main memory; and
the first sub-control circuit is configured to:
perform a writing into a first main memory area by performing a writing into the first sub-communication address space, the first main memory area being reserved in the main memory and being correlated with the first sub-communication address space; and
perform a reading out from the first main memory area by performing a reading out from the first sub-communication address space.

8. The printing apparatus according to claim 2, wherein:
the main control circuit includes a common memory correlated with or to be correlated with the first sub-control circuit and the second sub-control circuit; and
the first sub-control circuit is configured to:
perform a writing into the common memory by performing a writing into the first sub-communication address space correlated with the common memory; and
perform a reading out from the common memory by performing a reading out from the first sub-communication address space correlated with the common memory.

9. The printing apparatus according to claim 1, wherein:
the first sub-control circuit includes a first sub-register;
data to be written into the first main communication address space includes data different from data to be written into the first sub-memory; and
the first sub-control circuit is configured to write the data different from the data to be written into the first sub-memory into the first sub-register correlated with the first main communication address space.

10. The printing apparatus according to claim 2, wherein:
the second sub-control circuit includes a second sub-register;
data to be written into the second main communication address space includes data different from data to be written into the second sub-memory; and
the second sub-control circuit is configured to write the data different from the data to be written into the second sub-memory into the second sub-register correlated with the second main communication address space.

11. The printing apparatus according to claim 4, wherein:
the third sub-control circuit includes a third sub-register;
data to be written into the third main communication address space includes data different from data to be written into the third sub-memory; and
the third sub-control circuit is configured to write the data different from the data to be written into the third sub-memory into the third sub-register correlated with the third main communication address space.

12. The printing apparatus according to claim 2, wherein:
the main control circuit includes a common register correlated with or to be correlated with the first sub-control circuit and the second sub-control circuit; and
the first sub-control circuit is configured to:
perform a writing into the common register by performing a writing into the first sub-communication address space correlated with the common register; and
perform a reading out from the common register by performing a reading out from the first sub-communication address space correlated with the common register.

13. The printing apparatus according to claim 12, wherein:
the second sub-control circuit is configured to reserve a second sub-communication address space in the second sub-control circuit; and
the second sub-control circuit is configured to:
perform a writing into the common register by performing a writing into the second sub-communication address space correlated with the first sub-communication address space; and
perform a reading out from the common register by performing a reading out from the second sub-communication address space correlated with the first sub-communication address space.

14. The printing apparatus according to claim 13, wherein:
the sub-control circuit group includes a third sub-control circuit positioned downstream of the second sub-control circuit;
the third sub-control circuit is configured to reserve a third sub-communication address space in the third sub-control circuit; and
the third sub-control circuit is configured to:
perform a writing into the common register correlated with the third sub-control circuit by performing a writing into the third sub-communication address space correlated with the second sub-communication address space; and
perform a reading out from the common register correlated with the third sub-control circuit by performing a reading out from the third sub-communication address space correlated with the second sub-communication address space.

15. The printing apparatus according to claim 1, wherein:
the head group includes a first head configured to be driven by the first sub-control circuit and a second head configured to be driven by the second sub-control circuit; and
the main control circuit is configured to:
write a first image data indicating an image to be formed by driving of the first head into the first main communication address space; and
write a second image data indicating an image to be formed by driving of the second head into the second main communication address space.

16. The printing apparatus according to claim 4, wherein:
the head group includes a third head configured to be driven by the third sub-control circuit; and
the main control circuit is configured to write a third image data indicating an image to be formed by driving of the third head into the third main communication address space.

17. The printing apparatus according to claim 7, wherein the first sub-control circuit is configured to read out, from the first sub-communication address space, a common parameter common to the first sub-control circuit, the second sub-control circuit, and the third sub-control circuit, or an individual parameter specific to the first sub-control circuit.

18. The printing apparatus according to claim 17, wherein the first sub-control circuit is configured to:
determine whether or not an address assignment to the first sub-communication address space has been completed; and
in a case that the address assignment to the first sub-communication address space has been determined to be completed, read out the common parameter or the individual parameter from the first sub-communication address space.

19. The printing apparatus according to claim 8, wherein:
the sub-control circuit group includes a third sub-control circuit positioned downstream of the second sub-control circuit; and
the main control circuit is configured to write a parameter common to the first sub-control circuit, the second sub-control circuit, and the third sub-control circuit into the common memory.

20. The printing apparatus according to claim 12, wherein the first sub-control circuit is configured to perform a writing into the common register by writing data indicating occurrence of an abnormal situation into the first sub-communication address space.

21. A data transferring method executed in a printing apparatus,
the printing apparatus including:
a main control circuit;
a sub-control circuit group connected to the main control circuit in series, the sub-control circuit group being configured to transfer data from the main control circuit downstream; and
a head group configured to be driven by the sub-control circuit group based on the data, wherein:
the sub-control circuit group includes a first sub-control circuit connected to the main control circuit, and a second sub-control circuit positioned downstream of the first sub-control circuit;
the main control circuit is configured to reserve a main communication address space in the main control circuit;
the first sub-control circuit is configured to reserve a first sub-communication address space in the first sub-control circuit; and
the first sub-control circuit includes a first sub-memory,
the method comprising:
in a case that the data is written into a first main communication address space, write the data written into the first main communication address space into the first sub-memory by the first-sub control circuit, the first main communication address space being reserved in the main communication address space and being correlated with the first sub-memory; and
in a case that the data is written into a second main communication address space reserved in the main communication address space, write the data written into the second main communication address space into the first sub-communication address space by the first-sub control circuit.

22. A non-transitory computer-readable medium storing a program that is executable by a printing apparatus,
the printing apparatus including:
a main control circuit;
a sub-control circuit group connected to the main control circuit in series, the sub-control circuit group being configured to transfer data from the main control circuit downstream; and
a head group configured to be driven by the sub-control circuit group based on the data, wherein:
the sub-control circuit group includes a first sub-control circuit connected to the main control circuit, and a second sub-control circuit positioned downstream of the first sub-control circuit;
the main control circuit is configured to reserve a main communication address space in the main control circuit;
the first sub-control circuit is configured to reserve a first sub-communication address space in the first sub-control circuit; and
the first sub-control circuit includes a first sub-memory,
the program is configured to cause the first sub-control circuit to execute a process of:
in a case that the data is written into a first main communication address space, writing the data written into the first main communication address space into the first sub-memory, the first main communication address space being reserved in the main communication address space and being correlated with the first sub-memory; and
in a case that the data is written into a second main communication address space reserved in the main communication address space, writing the data written into the second main communication address space into the first sub-communication address space.
